(19) United States
(12) Patent Application Publication
(10) Pub. No.: US 2026/0046216 A1
(43) Pub. Date: Feb. 12, 2026

(54) ENHANCED USER PLANE TO FACILITATE EXCHANGE OF DATA

(71) Applicant: Dell Products L.P., Round Rock, TX (US)

(72) Inventor: Prashanth Murthy, Plano, TX (US)

(21) Appl. No.: 18/797,463

(22) Filed: Aug. 7, 2024

(51) Int. Cl. H04L 41/16; G06N 3/0985; H04W 24/02; H04W 92/20

(52) U.S. Cl. CPC H04L 41/16; G06N 3/0985; H04W 24/02; H04W 92/20

(57) ABSTRACT

Management and performance of distributed and federated learning can be enhanced. Core network can comprise UPF, AF, and AI component. AI component can train global AI model, located in core network, based on first AI-related data contained in a first container received from first base station by UPF. The trained global AI model can generate second AI-related data based on first input data input to the trained global AI model. AF and/or UPF can communicate a second container, comprising the second AI-related data, to second base station to facilitate training or updating a local AI model located at second base station. The trained or updated local AI model can generate a prediction or inference based on second input data input to the trained or updated local AI model. Second base station can communicate information relating to the prediction or inference to a device associated with second base station.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise training, by a system comprising at least one processor, a global artificial intelligence model located in a core network to generate a trained global artificial intelligence model based on first artificial intelligence-related data contained in a first container received from a first base station by network equipment of the core network. The method also can comprise communicating, by the system, a second container, comprising second artificial intelligence-related data, to a second base station to facilitate training or updating a local artificial intelligence model located at the second base station, wherein the second artificial intelligence-related data can be determined based on the trained global artificial intelligence model.

In certain embodiments, the disclosed subject matter can comprise a system that can comprise at least one memory that can store computer executable components, and at least one processor that can execute computer executable components stored in the at least one memory. The computer executable components can comprise a model trainer that can train a first artificial intelligence model located in a core network, based on first artificial intelligence-related information, to generate a trained first artificial intelligence model, wherein a first container, comprising the first artificial intelligence-related information, can be received from a first base station by network equipment of the core network. The computer executable components also can comprise an application function that can transmit a second container, comprising second artificial intelligence-related information, to a second base station to facilitate training a second artificial intelligence model located at the second base station, wherein the second artificial intelligence-related information can be determined based on the trained first artificial intelligence model.

In still other embodiments, the disclosed subject matter can comprise a non-transitory machine-readable medium, comprising executable instructions that, when executed by at least one processor, can facilitate performance of operations. The operations can comprise receiving, by network equipment of a core network, a first container, comprising first artificial intelligence-related data, from a first base station, wherein a first artificial intelligence model located in the core network can be trained, based on the first artificial intelligence-related data, to generate a trained global artificial intelligence model. The operations also can comprise communicating a second container, comprising second artificial intelligence-related data, to a second base station to facilitate training or updating a second artificial intelligence model located at the second base station, wherein the second artificial intelligence-related data can be determined based on the trained first artificial intelligence model.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and perform distributed and federated learning to facilitate training and updating global artificial intelligence (AI) model of the core network and local AI models of base stations of a radio access network(s) (RAN(s)), in accordance with various aspects and embodiments of the disclosed subject matter.

FIG. 2 depicts a block diagram of a non-limiting example system that can desirably manage and perform distributed and federated learning, including enabling the use of unstructured or transparent containers to exchange data, including AI-related data, between the RAN and the core network, in accordance with various aspects and embodiments of the disclosed subject matter.

FIG. 3 illustrates a block diagram of a non-limiting example process flow that can demonstrate example interactions of network elements in connection with performing distributed and federated learning, including the use of unstructured or transparent containers to exchange data, including AI-related data, between the RAN and the core network, in accordance with various aspects and embodiments of the disclosed subject matter.

FIG. 4 depicts a block diagram of a non-limiting example AI component that can perform AI-based analysis on data and generate AI-based analysis results, in accordance with various aspects and embodiments of the disclosed subject matter.

FIG. 5 illustrates a block diagram of a non-limiting example system that can desirably manage and perform distributed and federated learning to facilitate training and updating global AI model of the core network and local AI models of base stations of a RAN(s), in accordance with various aspects and embodiments of the disclosed subject matter.

FIG. 6 depicts a block diagram of non-limiting example system that can comprise a container component in a base station in an open RAN (O-RAN) communication network environment to facilitate desirable management and performance of distributed and federated learning to facilitate training and updating local AI models of base stations of the RAN(s) and global AI models of the core network, in accordance with various aspects and embodiments of the disclosed subject matter.

FIG. 7 depicts a diagram of a non-limiting example base station that can desirably facilitate connections and communication of information associated with devices, in accordance with various aspects and embodiments of the disclosed subject matter.

FIG. 8 illustrates a diagram of a non-limiting example device that can be operable to engage in a system architecture that facilitates wireless communications according to one or more embodiments described herein, in accordance with various aspects and embodiments of the disclosed subject matter.

FIG. 9 illustrates a flow chart of an example method that can desirably manage distributed and federated learning to train a global AI model associated with the core network based on first AI-related data received from a first base station and communicate second AI-related data generated by the global AI model to a second base station to train a local AI model associated with the second base station, in accordance with various aspects and embodiments of the disclosed subject matter.

FIG. 10 depicts a flow chart of an example method that can desirably manage distributed and federated learning to train a global AI model associated with the core network based on first AI-related data received from a first base station and second AI-related data received from a device, and communicate third AI-related data generated by the global AI model to a second base station to train a local AI model associated with the second base station, in accordance with various aspects and embodiments of the disclosed subject matter.

FIG. 11 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can enhance a user plane, a radio access network (RAN), and a core network of a communication network to facilitate desirable exchange of data to support artificial intelligence (AI) and machine learning (ML) uses. In 5^{th} generation (5G) new radio (NR), in the RAN, one objective can be to improve network performance and user experience using data that can be collected and processed autonomously. Certain AI/ML use cases have been identified for deployment in the following scenarios: AI/ML model training can be located in an operations, administration, and management (OAM) node, and AI/ML model inference can be located in the RAN node (e.g., NG-RAN node, such as a base station); and AI/ML model training and AI/ML model inference can both be located in the RAN node.

There can be an interface, known as an Xn interface, that can be between base stations (e.g., gNodeBs (gNBs)) of the RAN. The Xn interface can facilitate data collection from neighboring base stations (e.g., neighboring cells), among other things. In the core network, certain functions can be focused on providing assistance to AI/ML applications. For instance, the core network can comprise a service-based interface (SBI) from a user plane function (UPF) to an application function (AF) and certain other network functions (NFs) of the core network. Based on operator policy, the core network can share data with third-party applications in the AF through the SBI.

Existing systems and techniques can be deficient in a number of ways. For instance, with regard to existing systems and techniques, there may be no data collection mechanism when the Xn interface is unavailable. There can be Xn application protocol (XnAP) procedures that can exchange data for certain use cases, with specific information elements (IEs) that can be relevant to those certain use cases. For example, with regard to two RAN nodes (e.g., base stations), an AI/ML model can provide handover and mobility optimization for the case where the Xn interface can be involved in an inter-RAN node handover. However, this mechanism cannot be used for a next generation (NG)-based handover, since there may be no data collection possible from the neighboring RAN nodes when the Xn interface does not exist or is otherwise unavailable.

Another deficiency of existing systems and techniques can be the undesirably limited scope of distributed and federated learning. For instance, with existing systems and techniques, distributed and federated learning can be limited to the application layer, wherein a global model (e.g., global AI/ML model in the cloud) can aggregate local models that can be partially trained in the user equipment (UE), and the global model can be updated based on UE feedback.

It can be desirable (e.g., suitable, beneficial, advantageous, useful, improved, or optimal) if the scope of distributed and federated learning can be expanded in the core network to include applications in the RAN, and the systems, methods, and techniques disclosed herein desirably can expand the scope of distributed and federated learning in the core network to include applications in the RAN. For instance, the systems, methods, and techniques disclosed herein desirably can expand the scope of distributed and federated learning such that respective RAN nodes can train respective local AI/ML models, and the core network (e.g., the AF or network data analytics function (NWDAF) of the core network can train a global AI/ML model) in an iterative manner with the ability to exchange AI/ML model-related data (e.g., model parameters, training results, and/or other AI/ML model-related data), such as described herein. This expansion of the scope of distributed and federated learning can provide a number of advantages. For example, in the case of a distributed unit (DU) of the RAN node being co-located with a central unit (CU) of the RAN node at the cell site, or a distributed RAN in general, AI/ML model training at the core network can save or reduce the cost of deploying AI capability at each cell site and the associated resource consumption (e.g., computing power and/or energy consumption), and more AI/ML use cases that can be suitable for distributed and federated learning can be supported. As another example, in a centralized RAN case where the DU can be located at the cell site and the CU can be co-located with, or at least relatively nearer to, the UPF and NFs implementing AI/ML applications, the systems, methods, and techniques disclosed herein desirably can leverage the infrastructure for AI/ML model training at the core network, which can result in desirable cost reduction and/or reduction in resource usage. Similarly, the systems, methods, and techniques disclosed herein desirably can leverage the infrastructure for AI/ML model training at the core network in the case where the UPF is at edge sites (e.g., sites at or near cell sites) with multi-access edge computing (MEC) applications that can provide desirable cost reduction and/or reduction in resource usage.

Existing systems and techniques also can be deficient in that AI/ML applications in the RAN undesirably can be decoupled from the application layer. The existing systems and techniques can provide means for the RAN to support a few limited cases by coordinating with AI/ML models within the RAN. The application layer in the core network can interact with UEs (e.g., end devices) for federated learning. However, this can be inefficient in certain applications that can be attempting to arrive at similar predictions. For example, the XnAP procedure can define IEs to exchange UE trajectory prediction information that can be used by the target RAN node for handover decisions.

It similarly can be desired, and the systems, methods, and techniques disclosed herein desirably can provide, for an AF in the core network that can implement a value-add service and/or location-based services with the aid of, for example, predicted UE location as provided by the trained AI/ML models, such as described herein. This particular AI/ML use case can involve (e.g., can want or require; can be implemented or facilitated by) separate AI/ML model training at the RAN and the core network. It can be more desirable (e.g., more suitable, efficient, improved, or optimal) to implement this, and the systems, methods, and techniques disclosed herein desirably can implement this, with distributed and federated learning with the AI/ML model(s) trained using data from both the UE protocol layers and the application layer.

Still another deficiency of existing systems and techniques can relate to hyperparameter tuning within the RAN. AI/ML applications can suffer from overfitting an underfitting that can be attributed to the quality of the training dataset and hyperparameters of the trained AI/ML model. Because of such overfitting an underfitting issues, it can be desirable (e.g., wanted or needed) for the AI/ML model to be frequently (e.g., constantly) updated based on metrics such as prediction accuracy and F1 score (e.g., a score or measurement of accuracy of the AI, ML, or classification model). Existing systems and techniques can employ an existing mechanism of exchanging data over XnAP, however, this existing mechanism of exchanging data over XnAP may not provide a means to desirably update the AI/ML models based on metrics such as prediction accuracy and F1 score.

It can be desirable to have, and the systems, methods, and techniques disclosed herein desirably can provide or implement (e.g., efficiently and with minimal impact to standards or specifications), a mechanism (e.g., a transparent mechanism) that can be or can comprise a means of exchanging data over XnAP, which can allow for exchanging of AI/ML model-related data (e.g., model specific data or other model-related data) between RAN nodes, to desirably (e.g., frequently, constantly, suitably, sufficiently, efficiently, enhancedly, or optimally) update the AI/ML models based on metrics such as prediction accuracy and F1 score. For example, if a better prediction accuracy can be achieved with a certain activation function and hyperparameters of a neural network for a first RAN node, the systems, methods, and techniques disclosed herein desirably can leverage and use such information (e.g., the certain activation function and hyperparameters, or a similar activation function and similar hyperparameters derived from the certain activation function and hyperparameters) at a second RAN node for the same or similar use case (e.g., AI/ML use case) such that the second RAN node can benefit from such information for the same or similar use case.

Accordingly, the disclosed subject matter can address and overcome the aforementioned deficiencies and other deficiencies of the existing systems and techniques. To that end, techniques that can desirably (e.g., automatically, dynamically, suitably, reliably, efficiently, enhancedly, and/or optimally) manage and perform distributed and federated learning to facilitate training and updating global AI model of the core network and local AI models of base stations of a RAN(s) are presented. A system can comprise a communication network that can comprise one or more RANs. A RAN can comprise one or more base stations that can facilitate communication (e.g., wireless communication) of data between devices associated with the communication network (e.g., communicatively connected to a base station of the communication network, or otherwise connected to the communication network).

The communication network can comprise a core network that can be associated with (e.g., communicatively connected to) the one or more RANs. The core network can comprise various network functions, components, and equipment, including, for example, the UPF, AF, application server, and AI component. The UPF can receive a first container, comprising first AI-related data, from a first base station of the RAN, which can forward the first AI-related data (and/or the first container) to the AF or associated application server. In some embodiments, a first local AI model (e.g., a first trained local AI model), located at the first base station, can generate the first AI-related data based at least in part on first input data that can be input to the first local AI model.

The AI component can train (or update) a global AI model (e.g., a global AI, ML, or neural network model), located in the core network, based at least in part on the first AI-related data. The trained global AI model can generate second AI-related data based at least in part on second input data input to the trained global AI model. The second AI-related data can relate to operations, functions, parameters, and/or other features of a second base station, the first base station, the RAN, the core network, and/or devices.

The AF can employ a container manager component that can generate a second container that can comprise the second AI-related data. The AF and/or UPF can communicate the second container, comprising the second AI-related data, to the second base station to facilitate training or updating a second local AI model located at the second base station.

The second base station (e.g., employing its local AI component) can train or update (e.g., update or refine training of) the second local AI model based at least in part on the second AI-related data. The second trained (and/or updated) local AI model can generate a prediction or inference relating to operations, functions, parameters, and/or other features of the second base station and/or a device associated with the second base station based at least in part on third input data input to the second trained local AI model. In some embodiments, the second base station can communicate information relating to the prediction or inference to the device, for example, to facilitate controlling or modifying operation, functionality, or a parameter(s) of the device.

In certain embodiments, the first base station can communicate AI-related data destined to the second base station, even if there is no interface (e.g., no Xn interface) between the first base station and the second base station. For instance, the first base station can communicate a third container, comprising the AI-related data (e.g., generated by the first trained local AI model), to the UPF of the core network (e.g., via an N3 interface between the first base station and the UPF). The UPF (and/or AF or associated application server) can communicate a fourth container, comprising the AI-related data, to the second base station (e.g., via an N3 interface between the second base station and the UPF). The local AI component of or associated with the second base station can train or update the second local AI model based at least in part on the AI-related data input to and analyzed by the second local AI model.

The disclosed subject matter, by employing the container manager component, the enhanced containers, and the enhanced techniques described herein, can desirably (e.g., automatically, dynamically, suitably, reliably, efficiently, enhancedly, and/or optimally) communicate data, including AI-related data, between the core network and the RAN, between base stations of the same RAN or of different RANs, and/or between the core network and devices. The disclosed subject matter, by employing the container manager component, the enhanced containers, and the enhanced techniques described herein, also can desirably update a global AI model of the core network based at least in part on AI-related data received from the RAN(s) and/or the device(s), and/or can desirably update a local AI model of a base station based at least in part on AI-related data received from the core network, another base station, and/or the device(s). The disclosed subject matter, by employing the container manager component, the enhanced containers, and the enhanced techniques described herein, and the enhanced trained or updated global AI model of the core network and the enhanced trained or updated local AI models of the base stations, also can desirably perform enhanced predictions, inferences, and/or determinations relating to operations, functions, parameters, or features of the core network, RAN(s), and device(s), and can enhance overall performance of the core network, RAN(s), and device(s).

These and other aspects and embodiments of the disclosed subject matter will now be described with respect to the drawings.

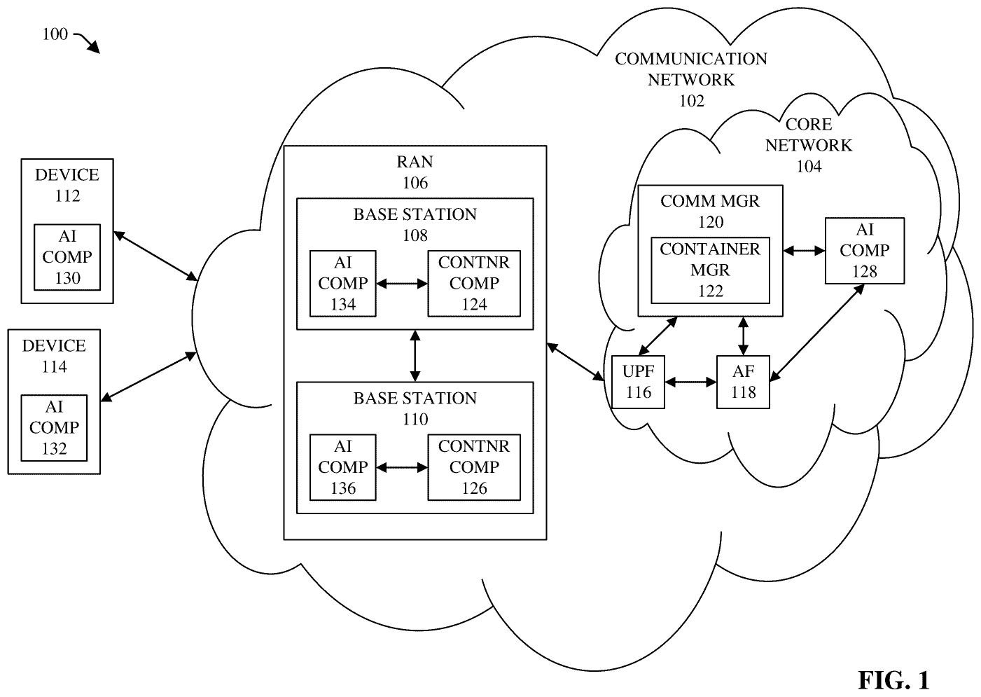

Referring now to the drawings, FIG. 1 illustrates a block diagram of a non-limiting example system 100 that can desirably (e.g., automatically, dynamically, suitably, reliably, efficiently, enhancedly, and/or optimally) manage and perform distributed and federated learning to facilitate training and updating (e.g., iteratively training and updating) global AI model of the core network and local AI models of base stations of a RAN(s), in accordance with various aspects and embodiments of the disclosed subject matter. The system 100 can comprise a communication network 102 that can comprise a core network 104 and one or more radio access networks (RANs), such as RAN 106, that can be associated with (e.g., communicatively connected to) the core network 104. Each RAN (e.g., RAN 106) can comprise one or more base stations, such as, for example, base station 108 and base station 110, that each can comprise one or more cells (not shown in FIG. 1).

The core network 104, the one or more RANs (e.g., RAN 106), the one or more base stations (e.g., base station 108 and/or base station 110), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 112 and/or 114. A device (e.g., 112 or 114) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 112 or 114) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) (e.g., base station 108 and/or base station 110) can be a 5G or other NR base station (e.g., gNB or other NR-type or xG base station, wherein x can be a number greater than 5). In some embodiments, the RAN 106 can be an open RAN (O-RAN) that can be part of an O-RAN architecture and environment (e.g., the communication network 102 can employ an O-RAN architecture and environment). In certain embodiments, the core network 104 can comprise a UPF 116 (also can be referred to as a UPF node), an AF 118 (also can be referred to as an AF node), an application server (not shown in FIG. 1 for reasons of brevity and clarity), an access and mobility management function (AMF) (not shown in FIG. 1 for reasons of brevity and clarity), and/or other network functions (not shown in FIG. 1 for reasons of brevity and clarity). The UPF 116 can connect to or interface with the one or more RANs (e.g., RAN 106) and the one or more base stations (e.g., base station 108 and/or base station 110), can be an interconnect point between the core network 104 and a data network (DN), can provide or facilitate providing a protocol data unit (PDU) session anchor point for providing mobility associated with radio access technologies (RATs), can provide or facilitate providing data packet routing or forwarding, and/or can perform or manage other functions.

The AF 118, which can be a control plane function, can be associated with, and can act as or fulfill all or part of the role of, the application server, and can interact and communicate with other network functions, including control plane functions, of the core network 104. The AF 118 and associated application server can facilitate (e.g., enable) provision of various services (e.g., voice services, messaging services, media streaming services, Internet and intranet services, multimedia conferencing and collaboration services, or other services) and applications to devices associated with the core network 104. Some of the services can be low latency services and/or network edge services. The AF 118 can comprise one or more AFs that respectively can be owned or managed by the network operator of the core network 104 or by third parties (e.g., trusted third parties). In some embodiments, the UPF 116 can be associated with, and can interact and communicate with, the AF 118 and/or other network functions (e.g., other control plane functions) via a service-based interface (SBI).

The AMF node can be a control plane function that can manage registration and deregistration of devices (e.g., devices 112 and/or 114) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) (e.g., base station 108 and/or base station 110) can be a 4^{th} generation (4G) long term evolution (LTE) RAN or base station, or the RAN or base station can comprise 4G LTE technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 112 and/or 114) and the communication network 102. The communication network 102, including the core network 104, can provide or facilitate wireless or wireline communication connections and channels between the one or more devices (e.g., devices 112 and/or 114), and/or respectively associated services or applications, and the communication network 102. For reasons of brevity or clarity, some of the various network equipment, components, functions, or devices of the communication network may not be explicitly shown or described herein.

At various times, the respective devices (e.g., devices 112 and/or 114) can utilize respective services. The services can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

As disclosed, existing systems and techniques can be deficient in a number of ways. For instance, with regard to existing systems and techniques, there may be no data collection mechanism when the Xn interface between base stations is unavailable or does not exist. Another deficiency of existing systems and techniques can be the undesirably limited scope of distributed and federated learning. Still another deficiency of existing systems and techniques can be that AI applications in the RAN undesirably can be decoupled from the application layer. Yet another deficiency of existing systems and techniques can relate to hyperparameter tuning within the RAN, including deficiencies with regard to updating of AI/ML models associated with base stations in the RAN.

The disclosed subject matter can overcome these deficiencies and other problems of existing techniques. To that end, in accordance with various embodiments, the system 100 can comprise a communication manager component 120 that desirably (e.g., automatically, dynamically, suitably, reliably, efficiently, enhancedly, and/or optimally) can perform and manage communication of data, including AI-related data, between the core network 104 and the one or more RANs, comprising the RAN 106, to facilitate distributed and federated learning in the communication network 102, in accordance with defined communication management criteria. The communication manager component 120 and the techniques described herein can comprise and employ enhancements to the user plane of or associated with the core network 104 to allow desirable and seamless exchange of information, including AI-related data, between the core network 104 and a RAN (e.g., RAN 106), between a RAN and another RAN, and between a base station (e.g., base station 108) and another base station (e.g., base station 110), in part, by leveraging flexibility for the network operator to exchange non-private information with third-party applications, and can leverage and benefit from AI training infrastructure and AI results at the data centers hosting network functions of the core network 104. The communication manager component 120, other components described herein, and the techniques described herein can employ an enhanced PDU session user plane (UP) protocol, an enhanced PDU set information UP protocol, and an enhanced general packet radio service (GPRS) tunneling protocol (GTP)-user plane (U) (GTP-U) extension header protocol to desirably transport unstructured data to facilitate (e.g., enable) a desirable deployment option for communication of data, including AI-related data, in the communication network 102. Unstructured data can be, for example, data for which the data structure is not defined by a specification or standard (e.g., the data structure is not defined by 3^{rd} Generation Partnership Project (3GPP) specifications, or other applicable specification or standard).

In some embodiments, to facilitate communication of such data between the core network 104 and the one or more RANs (e.g., RAN 106), the communication manager component 120 can employ enhanced and different PDU types (e.g., PDU type 2 and PDU type 3) in the PDU session user plane protocol that can enable PDU session containers (e.g., modified or enhanced PDU session containers (e.g., transparent containers)) to carry data (e.g., PDU data that can comprise AI-related data) between the core network 104 and the one or more RANs, such as described herein. In certain embodiments, to facilitate communication of such data between the core network 104 and the one or more RANs (e.g., RAN 106), the communication manager component 120 can employ an enhanced and different container, such as an unstructured container (e.g., unstructured container in an enhanced GTP-U extension header), that can carry unstructured data (e.g., unstructured PDU data that can comprise AI-related data) between the core network 104 and the one or more RANs, such as described herein. In still other embodiments, the communication manager component 120 also can comprise or can employ an enhanced and/or modified next generation application protocol (NGAP) that can enable communication of unstructured data, including AI-related data, between the core network 104 and the one or more RANs (e.g., RAN 106) using enhanced or modified containers (e.g., transparent containers), such as described herein.

As part of the GTP-U protocol, a PDU session container can be exchanged between the core network 104 and the RAN 106 without a tunnel PDU (T-PDU) on the N3 interface between the UPF 116 of the core network 104 and the RAN 106. In some embodiments, the communication manager component 120 (e.g., employing a container manager component 122) of the core network 104, and container components (e.g., container component 124 and/or container component 126) of the base stations (e.g., base station 108 and/or base station 110) can utilize enhanced PDU session containers to exchange data, including AI-related data, between the core network 104 (e.g., the UPF 116 of the core network 104) and the RAN (e.g., base station 108 and/or base station 110 of the RAN 106), in accordance with, and employing, the enhanced PDU session UP protocol, enhanced PDU set information UP protocol, and enhanced (GTP-U) protocol. The enhanced PDU session UP protocol and/or enhanced PDU set information UP protocol can specify or indicate encoding of an enhanced GTP-U extension header, such as described herein. In accordance with, and as part of, these enhanced protocols, the communication manager component 120, and the container components (e.g., container component 124 and/or container component 126), can, in addition to employing PDU session containers of PDU type 0 and PDU type 1, employ enhanced PDU session containers of PDU type 2 and PDU type 3 to transport data between the core network 104 and the RAN 106. The PDU type 0 can be utilized for communication of downlink PDU session data, PDU type 1 can be utilized for communication of uplink PDU session data, PDU type 2 can be utilized for communication of downlink transparent data (e.g., downlink AI-related data and/or other desired transparent data), and PDU type 3 can be utilized for communication of uplink transparent data (e.g., uplink AI-related data and/or other desired transparent data), wherein the transparent data can comprise, for example, AI-related data. The core network 104, employing the communication manager component 120, and the RAN 106, employing the container components (e.g., container component 124 and/or container component 126), can transport (e.g., communicate) containers of PDU type 2 and PDU type 3 in a same or similar manner as containers of PDU type 0 and PDU type 1, respectively, can be transported by the core network 104 and the RAN 106. In some embodiments, encoding of containers of PDU type 2 and PDU type 3 (e.g., by the container manager component 122, container component 124, and/or container component 126) can be model specific, and can be a standards-defined implementation (e.g., an open standard-defined implementation) or a closed-defined implementation.

In certain embodiments, to facilitate communication of data, including AI-related data, between the core network 104 and the RAN 106, and/or between base stations (e.g., between base station 108 and base station 110, and/or between a base station of the RAN 106 and another base station of another RAN), the communication manager component 120 (e.g., employing the container manager component 122), and the RAN 106 (e.g., employing the container component 124 of the base station 108 and/or the container component 126 of the base station 110) can employ the unstructured container, in the enhanced GTP-U extension header, that can carry unstructured data (e.g., unstructured PDU data that can comprise AI-related data and/or other desired data) between the core network 104 and the RAN 106. In some embodiments, encoding of the unstructured container (e.g., by the container manager component 122, container component 124, and/or container component 126) can be model specific, and can be a standards-defined implementation (e.g., an open standard-defined implementation) or a closed-defined implementation.

In accordance with various embodiments, the container manager component 122, container component 124, and/or container component 126 can employ the respective types of extension headers associated with (e.g., mapped or linked to) respective next extension header field values for respective containers of respective types, in accordance with non-limiting example TABLE 1 as follows:

TABLE 1

| Next Extension | |
|---|---|
| Header Field Value | Type of Extension Header |
| 0000 0000 | No more extension headers |
| 0000 0001 | Reserved - Control Plane only |
| 0000 0010 | Reserved - Control Plane only |
| 0000 0011 | Long PDCP PDU Number. See NOTE 2. |
| 0010 0000 | Service Class Indicator |
| 0100 0000 | UDP Port. Provides the UDP Source Port |
| | of the triggering message. |
| 1000 0001 | RAN Container |
| 1000 0010 | Long PDCP PDU Number. See NOTE 3. |
| 1000 0011 | Xw RAN Container |
| 1000 0100 | NR RAN Container |
| 1000 0101 | PDU Session Container. See NOTE 4. |
| 1100 0000 | PDCP PDU Number [4]-[5]. See NOTE 1. |
| 1100 0001 | Reserved - Control Plane only |
| 1100 0010 | Reserved - Control Plane only |
| 1110 0000 | Unstructured Container |

With regard to TABLE 1, NOTE 1 indicates that, as can be an exception to the comprehension rule specified for a G-PDU with a next extension header field set to the value “1100 0000,” the serving gateway (SGW) of the network can consider this corresponding extension header as “comprehension not required”; NOTE 2 indicates that this value (e.g., with regard to value “0000 0011” and the long PDCP PDU number) can be used by a source base station (e.g., eNodeB (eNB) or gNB) complying with this technical specification; NOTE 3 indicates that this value (e.g., with regard to with regard to value “1000 0010” and the long PDCP PDU number) is not to be by the source base station complying with the technical specification, and it may be received from a source base station (e.g., eNB) complying with an earlier release of the technical specification, e.g., not supporting the extension header value “0000 0011”; and NOTE 4 indicates that, for a GTP-PDU with several extension headers, the PDU session container should be the first extension header. It is to be appreciated and understood that TABLE 1 is merely a non-limiting example embodiment, and, in accordance with other embodiments, the container manager component 122, container component 124, and/or container component 126 can employ different next extension header field values, different types of extension headers, and/or different mappings between next extension header field values and types of extension headers than presented in TABLE 1.

In accordance with various embodiments, in accordance with TABLE 1, the container manager component 122, container component 124, and/or container component 126 can generate and/or transport an unstructured container associated with a next extension header field set to the value “1110 0000,” and, using the unstructured container, can communicate unstructured data, which can comprise AI-related data and/or other data, between the core network 104 (e.g., the UPF 116 of the core network 104) and the RAN 106 (e.g., base station 108 or base station 110 of the RAN 106). For example, the container manager component 122 can generate (e.g., create) an unstructured container associated with next extension header field value “1110 0000,” and can communicate the unstructured container, comprising AI-related data generated by the trained global AI model and/or other data, to a desired base station (e.g., base station 110). The container component (e.g., container component 126) at the base station can identify the container as an unstructured container based at least in part on the next extension header field value, and can retrieve the AI-related data from the unstructured container. Conversely, in a similar manner, the container component (e.g., container component 124) of a base station (e.g., base station 108) can generate an unstructured container associated with that next extension header field value, and can communicate that unstructured container, comprising AI-related data generated by its trained local AI model and/or other data, to the core network 104 (e.g., to the UPF 116, which can forward the unstructured container to the AF 118 or other desired destination).

In certain embodiments, a base station can utilize an unstructured container to communicate AI-related data (e.g., generated by its trained local AI model), to another base station via an Xn interface. For instance, the container component 124 of a first base station (e.g., base station 108) can communicate an unstructured container, comprising AI-related data and/or other desired data, to a second base station (e.g., base station 110) via an Xn interface between the first base station and the second base station, in accordance with the defined communication management criteria and associated disclosed enhanced protocols, wherein the container component (e.g., the container component 126) of the second base station can manage and process the unstructured container to retrieve the AI-related data and/or other desired data from the unstructured container.

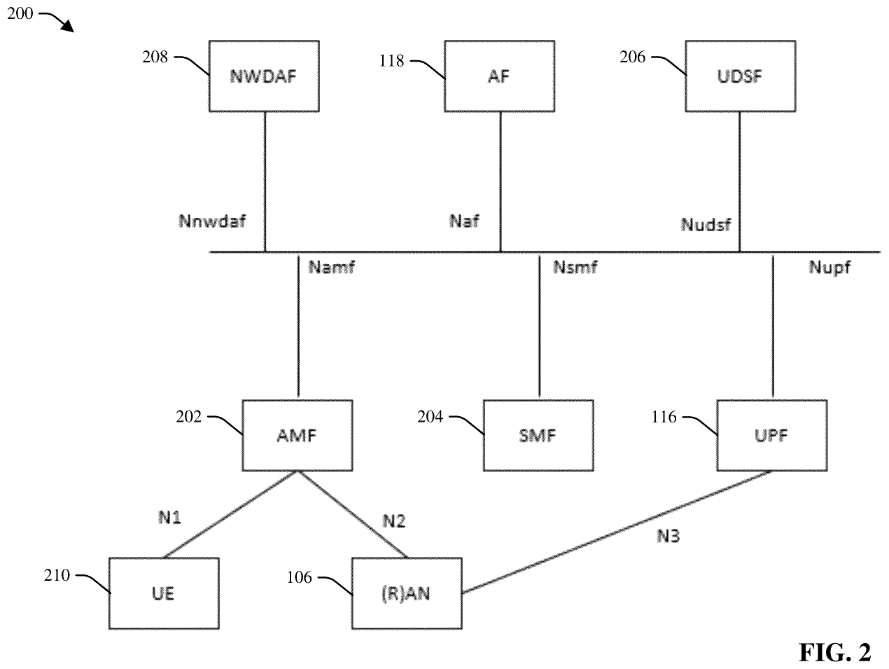

As disclosed, in accordance with various embodiments, the core network 104 can be enhanced and/or modified to enable the exchange of unstructured data (e.g., unstructured PDUs) between the RAN 106 and the core network 104. Referring to FIG. 2 (along with FIG. 1), FIG. 2 depicts a block diagram of a non-limiting example system 200 that can desirably (e.g., automatically, dynamically, suitably, reliably, efficiently, enhancedly, and/or optimally) manage and perform distributed and federated learning, including enabling the use of unstructured or transparent containers to exchange data, including AI-related data, between the RAN 106 and the core network 104, in accordance with various aspects and embodiments of the disclosed subject matter. In some embodiments, the system 200 can be part of the system 100 as shown in FIG. 1 and described herein.

The system 200 can comprise the core network 104 that can comprise the UPF 116, the AF 118, and the AMF 202, such as described herein. The core network 104 also can comprise a session management function (SMF) 204, an unstructured data storage function (UDSF) 206, a network data analytics function (NWDAF) 208, and/or other network functions (e.g., a network exposure function (NEF) and/or a time sensitive networking AF (TSNAF)/time sensitive communication and time synchronization function (TSCTSF) (not shown in FIG. 2) that can be associated with or part of the AF 118). The respective network functions can be associated with each other via the respective interfaces (e.g., Nupf, Naf, Namf, Nsmf, Nudsf, and Nnwdaf interfaces). The UPF 116 can be associated with (e.g., communicatively connected to or interfaced with) the RAN 106 via the N3 interface, and the AMF 202 can be associated with (e.g., communicatively connected to or interfaced with) the RAN 106 via an N2 interface. In some embodiments, the AMF 202 also can be associated with (e.g., communicatively connected to or interfaced with) a UE 210 (e.g., device 112 or device 114) via an N1 interface.

The SMF 204 can be part of the control plane of the core network 104, and can generate, update, or remove PDU sessions, manage session context with the UPF 116, selection and management of UPFs, UE network (e.g., Internet protocol (IP)) address allocation, and/or perform other functions. The UDSF 206 can be part of the control plane of the core network 104, and can be used as primary or secondary storage for storing data, which can comprise unstructured data (e.g., unstructured PDUs, which can include AI-related data), dynamic state data (e.g., UE context data or other UE-related data), data (e.g., session data) for stateless network functions, and/or other unstructured data.

The NWDAF 208 can be part of the control plane of the core network 104, and can perform an AI-based analysis (e.g., an AI/ML analysis) on data, can employ AI models (e.g., trained global AI, ML, or neural network models), and can perform predictive analytics on data for the core network 104. In accordance with various embodiments, the NWDAF 208 can be, can be part of, or can comprise an AI component (e.g., AI component 128, such as described herein), and/or can be an AI/ML host, and/or can employ an AI/ML application to facilitate performing AI-based analysis and functions, such as described herein. It is noted that, in certain embodiments, additionally or alternatively, the AF 118 can comprise an AI component (e.g., AI component 128, such as described herein), and/or can be an AI/ML host, and/or can employ an AI/ML application to facilitate performing AI-based analysis and functions, such as described herein. The NWDAF 208 can collect, consume, and analyze various data (e.g., statistics, metrics, event data relating to events, UE-related data, RAN-related data, core network-related data, and/or other data) from network functions of the core network 104, the RAN 106, UEs (e.g., device 112 and/or device 114), such as UE 210, and/or other components or data sources, can perform network function discovery and identification, can generate and train (e.g., iteratively train) AI models (e.g., AI models, ML models, neural network models, or other AI-based models) based at least in part on the results of performing AI-based analysis on the various data, perform or facilitate performing core network optimization, cost optimization, and resource management optimization for the core network 104, and/or perform other AI-based functions.

As disclosed, the core network 104 can comprise an SBI from the UPF 116 to the AF 118 and various other network functions (e.g., SMF 204, NWDAF 208, NEF/AF, TSNAF/TSCTSF, and/or other network functions) of the core network 104. Based at least in part on operator (e.g., core network operator) policy, the core network 104 can share data with third-party applications in the AF 118 through the SBI.

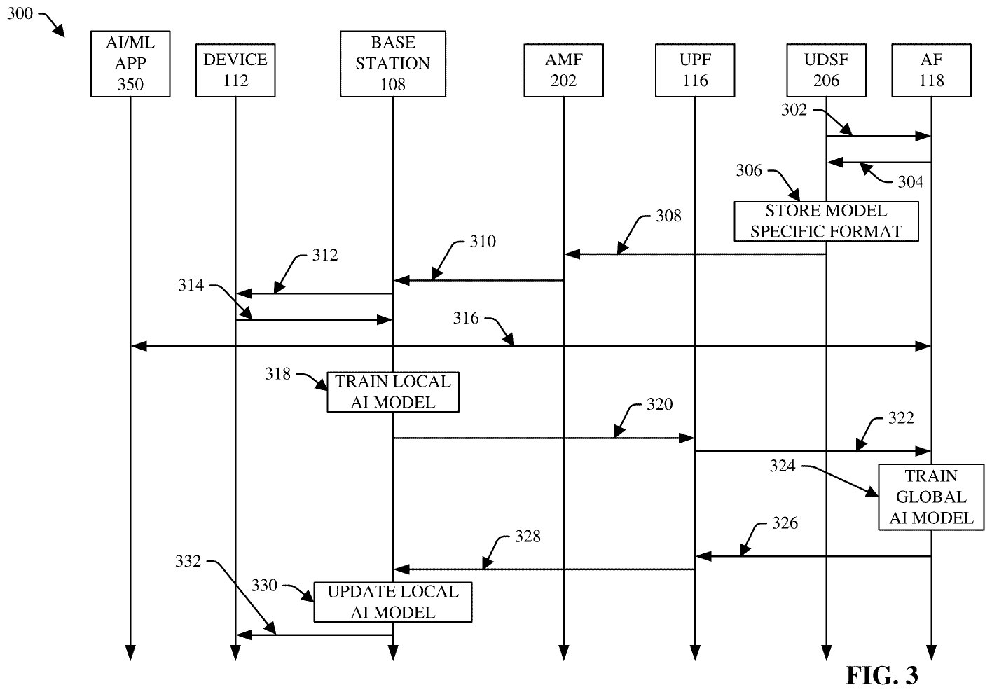

Referring to FIG. 3 (along with FIGS. 1 and 2), FIG. 3 illustrates a block diagram of a non-limiting example process flow 300 that can demonstrate example interactions of network elements in connection with performing distributed and federated learning, including the use of unstructured or transparent containers to exchange data, including AI-related data, between the RAN 106 and the core network 104, in accordance with various aspects and embodiments of the disclosed subject matter. The process flow 300 can relate to respective interactions and communications between respective components, including the device 112, an AI/ML application 350 of or associated with the device 112, the base station 108, the AMF 202, the UPF 116, the UDSF 206, and the AF 118 (and associated application server).

As indicated at reference numeral 302 of the process flow 300, the UDSF 206 can communicate a subscription request to the AF 118 to subscribe with the AF 118 with regard to unstructured data. As indicated at reference numeral 304, the AF 118 can communicate a notification message to the UDSF 206, wherein the notification message can notify the UDSF 206 is subscribed with the AF 118 with regard to unstructured data, and can comprise information relating to a model specific format for one or more AI models (e.g., a global AI model of the core network 104).

As indicated at reference numeral 306 of the process flow 300, the UDSF 206 can store the information relating to the model specific format. As indicated at reference numeral 308, the UDSF 206 can communicate a notification message to the AMF 202, wherein the AMF 202 can comprise information that can indicate an unstructured data definition for unstructured data to be communicated, and wherein the unstructured data definition can be based at least in part on the model specific format.

As indicated at reference numeral 310 of the process flow 300, the AMF 202 can communicate an NGAP data collection request message to the base station 108, wherein the NGAP data collection request message can comprise an NGAP data collection request and information that can indicate the unstructured data definition. As indicated at reference numeral 312, the base station 108 can communicate a measurement configuration to the device 112. As indicated at reference numeral 314, in response to the measurement configuration, the device 112 can communicate a measurement report to the base station 108, wherein the measurement report can comprise measurement information relating to measurements (e.g., device-related communication condition measurements or other device-related measurements) performed by the device 112 based at least in part on the measurement configuration information of the measurement configuration received from the base station 108.

As indicated at reference numeral 316 of the process flow 300, the AI/ML application 350 of or associated with the device 112 and the AF 118 can exchange data, including AI-related data, with each other via an application layer data exchange that can be facilitated by the application layer. For instance, the AI/ML application 350 (e.g., an AI component 130 of the device 112 employing the AI/ML application 350) can generate AI-related data associated with the device 112, and can communicate that AI-related information to the AF 118 via the application layer. It is noted that the device 114 similarly can comprise an AI component 132 that can employ an AI/ML application. The AI component (e.g., AI component 128) of or associated with the AF 118 can input such AI-related data to the global AI model, and can update the global AI model and/or have the global AI model generate results (e.g., AI-related data) based at least in part on the results of analyzing the input AI-related data. Also, the AI component (e.g., AI component 128) of or associated with the AF 118, and employing the global AI model, can generate AI-related data associated with the core network 104, the RAN(s) 106, and/or devices (e.g., device 112), and can communicate such AI-related data to the AI/ML application 350 via the application layer, and the AI/ML application 350 can input such AI-related data to the local (device) AI model, and can update the local AI model and/or have the local AI model generate results (e.g., AI-related data) based at least in part on the results of analyzing such input AI-related data.

As indicated at reference numeral 318 of the process flow 300, the base station 108 (e.g., employing an AI component 134 and local AI model generated and updated by the AI component 134) can train or update the local AI model of the base station 108 based at least in part on the measurement information contained in the measurement report received from the device 112. The local AI model of the base station 108 can generate model specific data, comprising AI-related data, based at least in part on the training or updating of the local AI model and/or subsequent data input to the trained or updated local AI model. In some embodiments, the model specific data can be unstructured data (e.g., as defined by the unstructured data definition). It is noted that the base station 110 similarly can comprise an AI component 136 that can generate, train, and update a local AI model of the base station 110.

As indicated at reference numeral 320 of the process flow 300, the base station 108 (e.g., employing the container component 124) can generate an unstructured or transparent container (e.g., an unstructured container, or a transparent PDU session container that can have a PDU type 3), and can communicate the unstructured or transparent container, comprising the model specific data generated by the local AI model of the base station 108, to the UPF 116 of the core network 104. As indicated at reference numeral 322, the UPF 116 can communicate the model specific data (e.g., unstructured model specific data) generated by the local AI model of the base station 108, to the AF 118 of the core network 104. In accordance with various embodiments, the UPF 116 can communicate the model specific data in the unstructured or transparent container (or a corresponding generated unstructured or transparent container), or can communicate the model specific data without using such container.

As indicated at reference numeral 324 of the process flow 300, the AF 118 (e.g., employing the AI component 128 of or associated with the AF 118) can train or update the global AI model based at least in part on the model specific data (e.g., unstructured model specific data) received from the base station 108 via the UPF 116. The global AI model can generate AI-related data based at least in part on the results of analyzing (e.g., performing an AI-based analysis on) the model specific data and/or other data (e.g., other data received from one or more devices, one or more base stations, one or more RANs, and/or one or more network functions). The AI-related data generated by the global AI model can be model specific data (e.g., update model specific data) generated by the global AI model that can be unstructured data.

As indicated at reference numeral 326 of the process flow 300, the AF 118 can communicate the model specific data (e.g., update model specific data) generated by the global AI model to the UPF 116. As indicated at reference numeral 328, the UPF 116 (e.g., employing the container manager component 122) can generate an unstructured or transparent container (e.g., an unstructured container, or a transparent PDU session container that can have a PDU type 2), comprising the model specific data (e.g., unstructured update model specific data) generated by the global AI model, and can communicate the unstructured or transparent container, comprising such model specific data, to the base station 108.

As indicated at reference numeral 330 of the process flow 300, the base station 108 (e.g., employing the AI component 134) can update the local AI model of the base station 108 based at least in part on the model specific data (e.g., update model specific data) received from the core network 104. For instance, the local AI model can analyze (e.g., perform an AI-based analysis on) the model specific data (e.g., update model specific data) and/or other data (e.g., data received from one or more devices and/or one or more other base stations). Based at least in part on the results of such analysis, the local AI model can be trained or updated. As part of the distributed and federated learning, the system (e.g., system 100, system 200, or other system described herein) can continue to train or update (e.g., iteratively train or update) the global AI model associated with the core network 104 and the local AI models associated with the base stations (as well as local AI models associated with the devices), in accordance with and employing the example process flow 300 and/or the other techniques described herein.

As indicated at reference numeral 332 of the process flow 300, the base station 108 can communicate action information relating to an action to the device 112, wherein the action can be an action that the base station 108 is performing (e.g., is taking) with respect to the device 112 or an action that the base station 108 is instructing the device 112 to perform, and wherein the action can be based at least in part on results of the analysis of the model specific data (e.g., update model specific data) and/or other data by the local AI model. Such results can comprise an inference, a prediction, and/or a determination generated by the local AI model based at least in part on such analysis. The device 112 can correspondingly respond to the action performed by the base station 108, or can perform a desired action, based at least in part on the action information received from the base station 108.

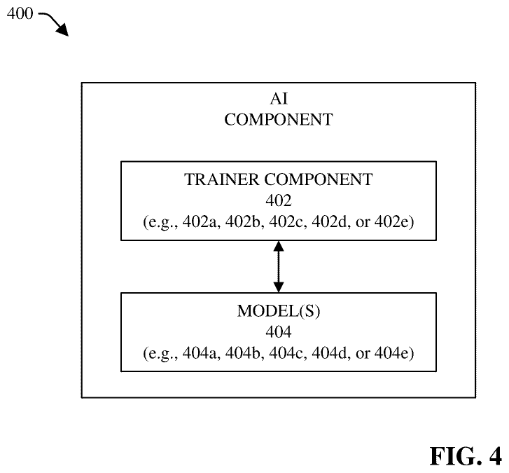

Referring to FIG. 4 (along with FIGS. 1 and 2), FIG. 4 depicts a block diagram of a non-limiting example AI component 400 that can perform AI-based analysis on data and generate AI-based analysis results, in accordance with various aspects and embodiments of the disclosed subject matter. In accordance with various embodiments, the example AI component 400 can be an AI component (e.g., AI component 128) located in or associated with the core network 104, an AI component (e.g., AI component 134 or AI component 136) located in or associated with a base station (e.g., base station 108 or base station 110), or an AI component (e.g., AI component 130 or AI component 132) located in or associated with a device (e.g., device 112 or device 114). The respective AI components (e.g., AI component 128, AI component 130, AI component 132, AI component 134, or AI component 136) can be same as, similar to, or different from each other.

The AI component 400 (e.g., AI component 128, AI component 130, AI component 132, AI component 134, or AI component 136) can comprise a trainer component 402 (e.g., AI component 128 can comprise trainer component 402a, AI component 130 can comprise trainer component 402b, AI component 132 can comprise trainer component 402c, AI component 134 can comprise trainer component 402d, or AI component 136 can comprise trainer component 402e), and a model(s) 404 (e.g., AI component 128 can comprise one or more trained AI-based models 404a, AI component 130 can comprise can comprise one or more trained AI-based models 404b, AI component 132 can comprise can comprise one or more trained AI-based models 404c, AI component 134 can comprise can comprise one or more trained AI-based models 404d, or AI component 136 can comprise one or more trained AI-based models 404c). The AI component 400 can perform an AI-based analysis on data, such as information relating to communication sessions, operations, functions, parameters, and/or other features associated with devices (e.g., device 112 and/or device 114), the RAN(s) 106, and/or the core network 104, information relating to models 404, including AI-related data received from another device or component (e.g., via a container), and/or feedback information (e.g., feedback information from a user, a device, a base station, network equipment or network function of the core network 104, or another data source). In some embodiments, with regard to a model 404, the AI component 400 can input such information into the (trained) model 404 for analysis by the model 404 to update the model 404 or to generate output results (e.g., AI-related data) based at least in part on the analysis of the input information.

In connection with or as part of such an AI-based analysis, the AI component 400 can employ, build (e.g., construct or create), and/or import, AI-based techniques and algorithms, AI models 404 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about relationships between components (e.g., base stations, cells, network nodes, communication links, devices, or other components or functions) of or associated with the communication network 102, determining or learning about data traffic associated with a communication session between a base station and a device, determining a group of parameters associated with a device, a base station, or network equipment or a network function of the core network 104, determining a configuration or a group of settings of a device, a base station, or network equipment or a network function of the core network 104, determining quality of service (QoS) associated with data traffic, performing other desired functions or operations, and/or automating one or more functions or features of the disclosed subject matter, as more fully described herein.

The AI component 400 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 400 can examine the entirety or a subset of the data (e.g., the training data; the operational data relating to the communication network 102, the core network 104, a device (e.g., device 112 and/or device 114), a RAN (e.g., the RAN 106), a base station (e.g., base station 108 and/or base station 110), and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 400 and/or the trained model(s) 404 can employ one or more threshold probabilities (e.g., threshold probability values) to facilitate making a determination. For instance, in making a determination (e.g., relating to data traffic, operations of a device, operations of a base station, operations of a RAN, operations of network equipment or network function of the core network 104, the group of parameters, the configuration or the group of settings, QoS, or other element or function), as part of the AI-based analysis of information, the AI component 400 and/or the trained model(s) 404 can determine a probability (e.g., a probability of performance enhancement relating to data traffic, operations of a device, operations of a base station, operations of a RAN, operations of network equipment or network function of the core network 104, the group of parameters, or other element, function, feature, or characteristic associated with a device, base station, RAN, or core network), and can determine whether the probability (e.g., probability value) satisfies (e.g., meets or exceeds; or is at or greater than) a defined and applicable threshold probability. The AI component 400 and/or the trained model(s) 404 can make a determination (or prediction or inference) (e.g., relating to data traffic, operations of a device, operations of a base station, operations of a RAN, operations of network equipment or network function of the core network 104, the group of parameters, or other element, function, feature, or characteristic associated with a device, base station, RAN, or core network) based at least in part on the results of analyzing (e.g., comparing) the probability to the defined and applicable threshold probability (e.g., threshold minimum probability value). As a non-limiting example, the AI component 400 (e.g., AI component 128 of the core network 104) and/or the trained model(s) 404 (e.g., trained global AI model) can make a determination (or prediction or inference) that a particular group of parameters can be employed by a base station (e.g., base station 110) to enhance performance associated with the base station or a device (e.g., device 114) associated with that base station based at least in part on determining that a probability relating to (e.g., indicating) whether the particular group of parameters can enhance performance associated with the base station or the device satisfies the defined and applicable threshold probability (e.g., the probability is the highest probability, relative to other probabilities associated with other groups of parameters, and satisfies the defined and applicable threshold probability).

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 400 can employ a classifier that can perform an AI-based analysis on data. A classifier can map an input attribute vector, z=(z1, z2, z3, z4, . . . , zn), to a confidence that the input belongs to a class, as by f(2)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 400 (e.g., employing the trainer component 402) can comprise, generate, and/or train (e.g., iteratively train) AI models 404 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., base stations, cells, network nodes, communication links, devices, or other components or functions) of or associated with the communication network 102; data traffic (e.g., type of data traffic, amount of data traffic, or other characteristic of data traffic) associated with a communication session between a base station and a device; a group of parameters associated with a device, a base station, or network equipment or a network function of the core network 104 that can enhance performance of the device, base station, or network equipment or network function of the core network 104; a configuration or a group of settings of a device, a base station, or network equipment or a network function of the core network 104 that can enhance performance of the device, base station, or network equipment or network function of the core network 104; and/or an effect on performance, QoS, and/or power consumption as a result of modification of parameters, configuration, or settings; and/or to perform other desired functions or operations, and/or to automate one or more functions or features of the disclosed subject matter, as described herein.

For instance, the AI component 400 can employ the trainer component 402 that can train (iteratively train and/or refine or update training of) a (trained) AI model(s) 404 to perform such learning, determinations, predictions, or inferences, and/or perform such other desired functions or operations, and/or automate such functions of features, based at least in part on application of training data and/or feedback information to the (trained) AI model, wherein the training data and/or feedback information can comprise or relate to, for example, current or previous communication sessions associated with a device(s), services, data traffic associated with devices, parameters, configuration, or settings associated with the device(s), a base station(s), or network equipment or a network function(s) of the core network 104, the defined communication management criteria, threshold values, and/or other data. Such training of the trained AI model(s) 404 can enable the trained AI model(s) 404 to perform an AI-based analysis on information relating to a device(s), a base station(s), a RAN(s), network equipment or a network function(s) of the core network 104, wherein, based at least in part on the results of such AI-based analysis, the trained AI model(s) 404 can learn, determine, predict, or infer data patterns in data; a correlation, relationship, or causation between an item(s) of data and another item(s) of data; a correlation, relationship, or causation between an event and another event (e.g., occurrence of another event); relationships between components (e.g., base stations, cells, network nodes, communication links, devices, or other components or functions) of or associated with the communication network 102; data traffic (e.g., type of data traffic, amount of data traffic, or other characteristic of data traffic) associated with a communication session between a base station and a device; a group of parameters associated with a device, a base station, or network equipment or a network function of the core network 104 that can enhance performance of the device, base station, or network equipment or network function of the core network 104; a configuration or a group of settings of a device, a base station, or network equipment or a network function of the core network 104 that can enhance performance of the device, base station, or network equipment or network function of the core network 104; and/or an effect on performance, QoS, and/or power consumption as a result of modification of the parameters, the configuration, or the settings; and/or to perform other desired functions or operations, and/or to automate one or more functions or features of the disclosed subject matter.

In some embodiments, the AI component 400 (e.g., employing the trainer component 402) can update (e.g., modify, adjust, refine, or change), and further train and enhance, the trained AI model(s) 404 as additional data (e.g., information relating to further operation of, or modifications or changes to, the communication network 102, core network 104, RAN 106, base stations (e.g., 108 and/or 110), cells, devices (e.g., 112 and/or 114), parameters, configurations, settings, data traffic, QoS associated with data traffic, power consumption associated with a device or the communication network 102, services, and/or other functions, features, or operations; output results (e.g., AI-based analysis results) output from the AI model(s) 404 associated with an entity (e.g., a device, a base station, a RAN, or the core network 104) and/or output results output from another AI model(s) associated with another entity (e.g., another of a device, a base station, a RAN, or the core network 104); the feedback information; and/or other information) is received and analyzed by the AI component 400 or trained AI model(s) 404. In some embodiments, as part of the data analysis, and the determining and training of the AI models 404, the AI component 400 can employ (and/or train) Markov chains, a neural network(s), decision trees, or other AI-based modeling, techniques, functions, or algorithms.

In some embodiments, to facilitate desirable distributed and federated learning, the container component 124 of the base station 108 (e.g., a first base station) can generate a first container (e.g., enhanced PDU session container of PDU type 3 (e.g., transparent container of PDU type 3) or unstructured container), comprising first AI-related data (e.g., first unstructured or transparent AI-related data) generated by the AI component 134 (e.g., generated by a first local trained model of the base station 108), and can communicate the first container to the core network 104 (e.g., to the UPF 116, which can forward the first container and/or the first AI-related data to the AF 118 and/or AI component 128). In certain embodiments, the core network 104 (e.g., the AF 118 or application server of the core network 104) also can receive, via the application layer (e.g., via an application layer data exchange), second AI-related data generated by the AI component 130 of or associated with the device 112, from the AI application of or associated with the device 112. For instance, a trained local AI model of or associated with the device 112 can generate the second AI-related data based at least in part on the results of analyzing device-related information associated with the device 112 and/or one or more base stations (e.g., base station 108 and/or base station 110) that are or were associated with the device 112. The device 112 can communicate the second AI-related data to the core network 104 to facilitate updating the global AI model of the core network 104. The core network 104 also may receive other data (e.g., other AI-related data, feedback data, or other type of data) from one or more other data sources (e.g., another device, another base station, another type of data source device, or a user).

The AI component 128 (e.g., employing the trainer component 402a) can input the first AI-related data, the second AI-related data, and/or the other data into the trained global AI model of the core network 104. The global AI model can analyze (e.g., can perform an AI-based analysis on) the first AI-related data, the second AI-related data, and/or the other data. Based at least in part on the results of such analysis, the global AI model can be trained or further trained (e.g., updated or refined) to make (e.g., render or output) predictions, inferences, probabilities, determinations, or decisions relating to operations, functions, parameters, and/or features of the core network 104, the RAN(s) 106 (e.g., one or more base stations of the RAN(s)), and/or one or more devices (e.g., device 112 and/or device 114), and/or to provide (e.g., determine and/or generate) other output data relating to functions, parameters, and/or features of operations of the core network 104, the RAN(s) 106, and/or the one or more devices. For instance, based at least in part on the results of analyzing the first AI-related data, the second AI-related data, and/or the other data, and/or based at least in part on the results of analyzing subsequent data input (e.g., subsequently input) to the trained or updated global AI model, the trained or updated global AI model can generate third AI-related data relating to the base station 108, the base station 110 (e.g., a second base station), the device 112 (or another device, such as device 114), and/or the core network 104.

In some embodiments, the AF 118 and/or the container manager component 122 can generate a second container (e.g., enhanced PDU session container of PDU type 2 (e.g., transparent container of PDU type 2), unstructured container), comprising the third AI-related data generated by the global AI model, and can communicate the second container, comprising the third AI-related data (e.g., third unstructured or transparent AI-related data), to the base station 110 to facilitate training or updating a second trained or untrained local AI model located at the base station 110. For instance, the AF 118 or associated application server can communicate the second container, comprising the third AI-related data, to the UPF 116. The UPF 116 can communicate the second container, comprising the third AI-related data, to the base station 110 (e.g., via the N3 interface) to facilitate training or updating the second local AI model based at least in part on the third AI-related data.

The base station 110 can employ the AI component 136 (e.g., the trainer component 402e thereof) to input the third AI-related data and/or other data to the second local AI model to train or update the second local AI model. The second local AI model can analyze (e.g., perform an AI-based analysis on) the third AI-related data and/or the other data. Based at least in part on the results of such analysis, the second local AI model can be trained or updated, and/or can render and output predictions, inferences, probabilities, determinations, or decisions relating to operations, functions, parameters, and/or features of the base station 110 (or another base station, such as base station 108), one or more devices (e.g., device 112 and/or device 114), and/or the core network 104. As a non-limiting example, based at least in part on the analysis results, the second trained or updated local AI model can generate or determine a prediction or inference relating to location (e.g., a predicted future location at a future time), mobility (e.g., predicted mobility), or trajectory (e.g., predicted trajectory) of the device 112. The base station 110 can determine a desired first action (e.g., modify a parameter(s) of the base station 110 and/or device 112, handover the device 112 to another base station, communicate information or instructions relating to the second action to the device 112, or another action) to perform, and/or a desired second action (e.g., modify a parameter(s) of the device 112, facilitate handover of the device 112 to the other base station, or another action) for the device 112 to perform, based at least in part on the prediction or inference relating to the location, mobility, or trajectory of the device 112. The base station 110 can perform the first action with respect to the device 112 and/or can communicate information or instructions relating to the second action to the device 112 to have the device 112 perform the second action.

In accordance with various embodiments, the base station 108 can directly (e.g., via the Xn interface, using a container) or indirectly (e.g., via the core network 104, using containers) communicate AI-related data to the base station 110, or vice versa. In some embodiments, if there is no interface (e.g., no Xn interface) available between the base station 108 and the base station 110, the base station 110, employing the container component 124, can generate a container (e.g., an enhanced PDU session container of PDU type 3 (e.g., transparent container of PDU type 3), unstructured container), and the base station 108 can communicate the container, comprising the AI-related data (e.g., generated by the first trained local AI model of the base station 108) to the core network 104 (e.g., to the UPF 116 and/or AF 118 of the core network). The core network 104 (e.g., employing the UPF 116 and/or AF 118) can communicate the container, comprising the AI-related data to the base station 110 (e.g., via an N3 interface between the base station 110 and the UPF 116). In certain embodiments, if the interface (e.g., Xn interface) is available between the base station 108 and base station 110, the base station 110, employing the container component 124, can generate a container (e.g., an enhanced unstructured or transparent container), and the base station 108 can communicate the container, comprising the AI-related, to the base station 108 via the interface (e.g., Xn interface) between the base station 108 and base station 110. The base station 110 and/or its AI component 136 (e.g., second trained local AI model of the base station 110) can process and/or analyze the AI-related data (e.g., to update the second trained local AI model, and/or have such model render a prediction or inference relating to the base station 110 or a device, based at least in part on the results of analyzing the AI-related data), such as described herein. Based at least in part on such prediction or inference, the base station 110 can perform a desired action or can have a device (e.g., device 112 or device 114) perform a desired action, such as described herein.

As another non-limiting example, if the first trained local model of the base station 108 is able to achieve a desirable (e.g., suitable, efficient, enhanced, or optimal) performance (e.g., more desirable prediction accuracy) using a certain activation function and/or certain hyperparameters of the first trained local model (e.g., first trained neural network model or other AI model) under a certain set of conditions associated with the base station 108, core network 104, and/or device (e.g., device 112), the base station 108 (e.g., employing the container component 124) can directly (e.g., via the Xn interface, using a container) or indirectly (e.g., via the core network 104, using containers) communicate a container, comprising AI-related data (e.g., model specific data) to the base station 110, such as described herein, wherein the AI-related data can comprise information relating to the certain activation function, the certain hyperparameters, and/or the certain set of conditions.

The second trained local AI model of the base station 110 can analyze and/or utilize the AI-related data, comprising the information relating to the certain activation function, the certain hyperparameters, and/or the certain set of conditions, to apply the certain activation function and/or the certain hyperparameters for the second trained local AI model, and/or accordingly, render a prediction or inference relating to operation of the base station 110 or an associated device based at least in part on the certain activation function and/or the certain hyperparameters, if and when the second base station 110, the core network 104, and/or a device (e.g., device 112 or device 114) are subject to the same certain set of conditions or a similar set of conditions. Alternatively, in some embodiments, the second trained local AI model can analyze and/or utilize such AI-related data to determine, predict, or infer an adapted activation function and/or adapted hyperparameters for the second trained local AI model, based at least in part on the certain activation function, the certain hyperparameters, and/or the certain set of conditions, and the second trained local AI model can apply the adapted activation function and/or adapted hyperparameters, and/or, accordingly, can render a prediction or inference relating to operation of the base station 110 or an associated device based at least in part on the adapted activation function and/or the adapted hyperparameters, if and when the second base station 110, the core network 104, and/or a device (e.g., device 112 or device 114) are subject to the same certain set of conditions or a similar set of conditions.

As part of the distributed and federated learning, the system (e.g., system 100, system 200, or other system described herein), employing the respective AI components (and associated AI/ML applications) and/or the enhanced containers (e.g., unstructured or transparent containers) described herein, can continue to exchange information (e.g., AI-related data and/or other data) between the core network 104, the base stations 108 and 110, and the devices 112 and 114, and can continue to train or update (e.g., iteratively train or update) the global AI model associated with the core network 104 and the local AI models associated with the base stations 108 and 110 (as well as the local AI models associated with the devices 112 and 114), in accordance with and employing the techniques described herein.

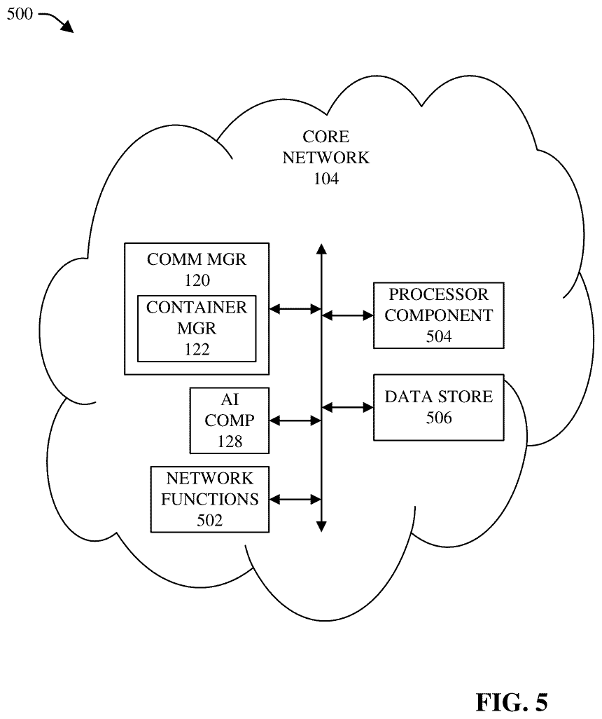

Turning to FIG. 5 (along with FIGS. 1 and 2), FIG. 5 illustrates a block diagram of a non-limiting example system 500 that can desirably (e.g., automatically, dynamically, suitably, reliably, efficiently, enhancedly, and/or optimally) manage and perform distributed and federated learning to facilitate training and updating (e.g., iteratively training and updating) a global AI model of the core network and local AI models of base stations of a RAN(s), in accordance with various aspects and embodiments of the disclosed subject matter. The system 500 can comprise the core network 104, the communication manager component 120, the container manager component 122, the AI component 128, and network functions 502 (e.g., UPF, AF, AMF, SMF, UDSF, NWDAF, NEF/AF, TSNAF/TSCTSF, and/or another network function), which can comprise the respective functionality and features described herein. In some embodiments, the system 500 can be part of the system 100 depicted in FIG. 1.

In accordance with various embodiments, the system 500 can comprise a processor component 504 that can be associated with (e.g., communicatively connected to) and can work in conjunction with other components of the system 500, including the communication manager component 120, the container manager component 122, the AI component 128, the network functions 502, a data store 506, and/or other components of the system 500, to facilitate performing the various functions and operations of the system 500. The processor component 504 can employ one or more processors (e.g., one or more central processing units (CPUs)), accelerators, graphics processing units (GPUs), application-specific integrated circuits (ASICs), microprocessors, or controllers that can process information relating to data, files, services, applications, communication network, core network, RANs, cells, devices, users, resources, communication sessions (e.g., PDU or other communication sessions), performance indicators, containers (e.g., PDU session containers, unstructured containers, transparent containers), UE protocol layers, application layer, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), downlink control information (DCI), congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced container generation and communication algorithms, hash algorithms, data compression algorithms, data decompression algorithms, and/or other algorithm), interfaces, protocols, tools, and/or other information, to facilitate operation of the system 500, and control data flow between the system 500 and/or other components (e.g., network equipment or components, the RAN 106 or another RAN, a base station (e.g., base station 108 or base station 110) of the RAN(s), the communication network 102, a device (e.g., 112 or 114), a node, an application, a service, a user, or other entity) associated with the system 500.

The data store 506 can store data structures (e.g., user data, metadata), code structure(s) (e.g., modules, objects, hashes, classes, procedures) or instructions, information relating to data, files, services, applications, communication network, core network, RANs, cells, devices, users, resources, communication sessions (e.g., PDU or other communication sessions), performance indicators, containers (e.g., PDU session containers, unstructured containers, transparent containers), UE protocol layers, application layer, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced container generation and communication algorithms, hash algorithms, data compression algorithms, data decompression algorithms, and/or other algorithm), interfaces, protocols, tools, and/or other information, to facilitate controlling or performing operations associated with the system 500. The data store 506 can comprise volatile and/or non-volatile memory, such as described herein. In an aspect, the processor component 504 can be functionally coupled (e.g., through a memory bus) to the data store 506 in order to store and retrieve information desired to operate and/or confer functionality, at least in part, to the communication manager component 120, the container manager component 122, the AI component 128, the network functions 502, the processor component 504, the data store 506, and/or other component of the system 500, and/or substantially any other operational aspects of system 500.

As disclosed, the data store 506 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

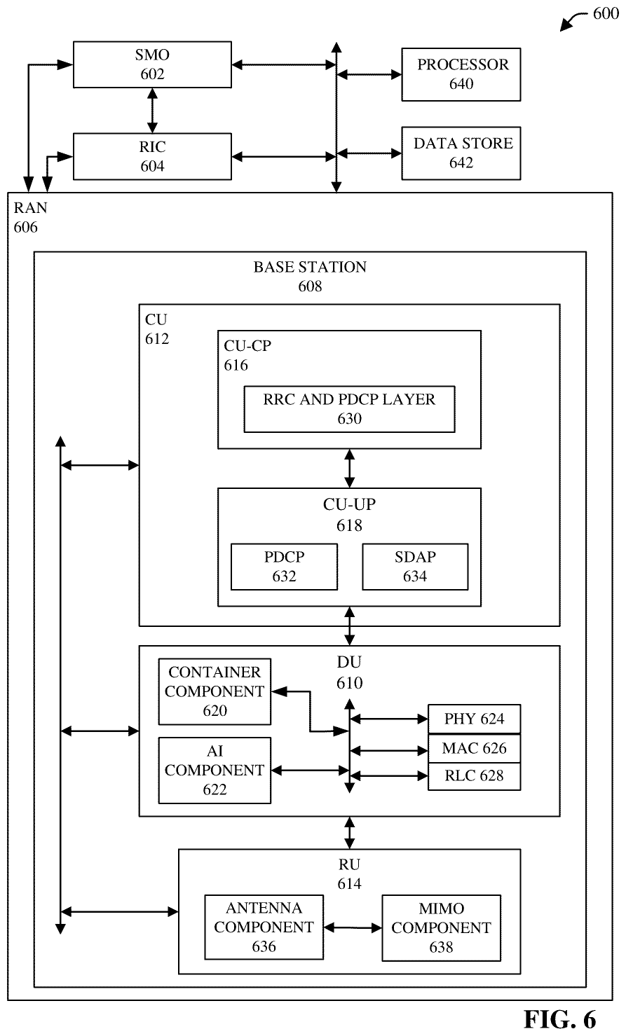

Turning to FIG. 6 (along with FIGS. 1 and 2), FIG. 6 depicts a block diagram of non-limiting example system 600 that can comprise a container component in a base station in an O-RAN communication network environment to facilitate desirable (e.g., suitable, reliable, efficient, enhanced, and/or optimal) management and performance of distributed and federated learning to facilitate training and updating (e.g., iteratively training and updating) local AI models of base stations of the RAN(s) and global AI models of the core network, in accordance with various aspects and embodiments of the disclosed subject matter. In some embodiments, the system 600 can be part of the system 100 depicted in FIG. 1.

The system 600 can comprise a service management and orchestration (SMO) 602, a RIC 604, and a RAN 606. In some embodiments, the RAN 606 can be an O-RAN that can be part of an O-RAN architecture and environment (e.g., the communication network 102 can employ an O-RAN architecture and environment). In certain embodiments, the RAN 606 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 606 may not be an O-RAN, C-RAN, or vRAN.

In accordance with various embodiments, the RAN 606 and associated communication network (e.g., communication network 102) can be part of a 5G or other new radio (NR) communication environment (e.g., an xG communication environment, wherein x can be 5 or a number greater than 5). With regard to 5G or other NR generation, the RAN 606 can comprise base stations, such as a gNodeB (gNB or NR-NB), that can be disaggregated into a CU (e.g., gNB or other NR-NB CU), comprising a CU-UP (e.g., gNB or other NR-NB CU-UP), a CU-control plane (CU-CP) (e.g., gNB or other NR-NB CU-CP), and a DU (e.g., gNB or other NR-NB DU). The CU-UP and DU can be part of the user plane node, with the CU-UP hosting PDCP and SDAP entities, and the DU can host the RLC, MAC, and PHY layers. For instance, the RAN 606 can comprise the base station 608 that can comprise a DU 610, a CU 612, and a radio unit (RU) 614 (e.g., a gNB or other NR-NB RU). The CU 612 can comprise a CU-CP 616 (also referred to as a CU-CP node) and a CU-UP 618 (also referred to as a CU-UP node). In certain embodiments, the RAN 606 and/or the base station 608 can comprise multiple DUs, multiple CU-CPs, multiple CU-UPs, and/or multiple RUs. In some embodiments, the DU 610, the CU 612, and the RU 614 can be co-located at a cell site. In other embodiments, one or more of the components (e.g., the CU 612, or at least part of the CU 612, such as the CU-CP 616) of the base station 608 can be located in different location than one or more other components (e.g., DU 610, RU 614, and/or CU-UP 618) of the base station 608.

In accordance with various embodiments, the system 600 can comprise the container component 620 that can be associated with (e.g., communicatively connected to or part of) the DU 610, the CU 612, the RU 614, or another component of or associated with the base station 608. In some embodiments, the container component 620 can be part of the DU 610 (as depicted in FIG. 6). In other embodiments, the container component 620 can be part of another component of or associated with the base station 608 or RAN 606. In still other embodiments, the container component 620 can be a separate component in the RAN 606 or base station 608, and can be associated with the DU 610 and/or one or more of the other components of the RAN 606 or base station 608. The container component 620 can comprise various components and functions, and can perform various operations, such as described herein.

In accordance with various embodiments, the system 600 can comprise the AI component 622 that can be associated with (e.g., communicatively connected to or part of) the DU 610, the CU 612, the RU 614, or another component of or associated with the base station 608. In certain embodiments, the AI component 622 can be part of the DU 610 (as depicted in FIG. 6). In other embodiments, the AI component 622 can be part of another component of or associated with the base station 608 or RAN 606. In still other embodiments, the AI component 622 can be a separate component in the RAN 606 or base station 608, and can be associated with the DU 610 and/or one or more of the other components of the RAN 606 or base station 608. The AI component 622 can comprise various components and functions, and can perform various operations, such as described herein.

The DU 610 can be a logical node that can host or handle baseband (e.g., PHY) 624 and layer 2 (L2) (e.g., a MAC layer 626 and a RLC layer 628) functionality associated with the base station 608. The CU-CP 616 can be a logical node that can host or handle layer 3 (L3) (e.g., a RRC and PDCP layer 630) control plane functionality associated with the base station 608. The CU-UP 618 can be a logical node that can host or handle data traffic between the core network 104 (e.g., 5G core network) and one or more DUs (e.g., the DU 610) to which the CU-UP 618 is connected. In some embodiments, the CU-UP 618 can comprise a PDCP component (PDCP) 632 that can perform PDCP functions, and an SDAP component (SDAP) 634 that can perform SDAP functions.

The RU 614 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 606 and other devices (e.g., devices 112 and/or 114) or components (e.g., components or functions of the core network 104 or communication network 102). In some embodiments, the RU 614 can comprise an antenna component 636 that can comprise an antenna array that can comprise a desired number of transmitter and receiver antennas to facilitate transmission and receiving of signals comprising information, and perform various beamforming, antenna-related, and communication-related functions. The RU 614 also can comprise a multiple input, multiple output (MIMO) component 638 that can be employed to generate or modify a number of MIMO spatial layers and a number of spatial streams employed by the base station 608 (e.g., with regard to a device(s)) during a communication session between the base station 608 and a device (e.g., device 112), and perform MIMO spatial multiplexing functions. In certain embodiments, the MIMO component 638 can be configured in a single user (SU)-type MIMO mode or a multiple user (MU)-type MIMO mode. In some embodiments, the MIMO component 638 can employ or support massive MIMO (mMIMO). The RU 614 also can comprise or be associated with other functions, including, for example, modulation and coding scheme (MCS) functions and transmit diversity functions.

In some embodiments, as disclosed, the system 600 can comprise an O-RAN architecture and environment, and the RAN 606 can be an O-RAN. In some embodiments, in the O-RAN architecture and environment, the SMO component 602 can be associated with (e.g., communicatively connected to) the RIC 604 and/or the RAN 606 (and/or one or more other RANs) via an interface(s) (e.g., an O1 interface, an A1 interface, or another interface), to facilitate communication of information between the SMO component 602 and the RIC 604 and/or the RAN 606 (and/or one or more other RANs), and the RIC 604 can be associated with the RAN 606 (and/or one or more other RANs) via an interface(s) (e.g., an E2 interface or another interface), to facilitate communication of information between the RIC 604 and the RAN 606 (and/or one or more other RANs).

The SMO component 602 can act and operate as a management and orchestration layer that can control configuration and automation aspects of the RIC 604 and RAN elements of the RAN(s) 606. The SMO component 602 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 604 can operate to control (e.g., manage) and enhance (e.g., improve or optimize) RAN functions and services of the RAN(s) 606. At least some of the various network functions and components of the RIC 604 can operate in real time or near real time, and some network functions and components of the RIC 604 may operate in non-real time.

In accordance with various embodiments, the system 600 can comprise a processor component 640 that can be associated with (e.g., communicatively connected to) and can work in conjunction with other components of the system 600, including the SMO component 602, the RIC 604, the RAN 606, the container component 620, the AI component 622, a data store 642, and/or other components of the system 600, to facilitate performing the various functions and operations of the system 600. The processor component 640 can employ one or more processors (e.g., one or more CPUs, accelerators, GPUs, ASICs, or other processors), microprocessors, or controllers that can process information relating to data, files, services, applications, communication network, core network, RANs, cells, devices, users, resources, communication sessions (e.g., PDU or other communication sessions), performance indicators, containers (e.g., PDU session containers, unstructured containers, transparent containers), UE protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced container generation and communication algorithms, AI algorithms, hash algorithms, data compression algorithms, data decompression algorithms, and/or other algorithm), interfaces, protocols, tools, and/or other information, to facilitate operation of the system 600, and control data flow between the system 600 and/or other components (e.g., network equipment, components, or functions, the communication network 102, the core network 104, another base station, a device (e.g., 112 or 114), a node, an application, a service, a user, or other entity) associated with the system 600.

The data store 642 can store data structures (e.g., user data, metadata), code structure(s) (e.g., modules, objects, hashes, classes, procedures) or instructions, information relating to data, files, services, applications, communication network, core network, RANs, cells, devices, users, resources, communication sessions (e.g., PDU or other communication sessions), performance indicators, containers (e.g., PDU session containers, unstructured containers, transparent containers), UE protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced container generation and communication algorithms, AI algorithms, hash algorithms, data compression algorithms, data decompression algorithms, and/or other algorithm), interfaces, protocols, tools, and/or other information, to facilitate controlling or performing operations associated with the system 600. The data store 642 can comprise volatile and/or non-volatile memory, such as described herein. In an aspect, the processor component 640 can be functionally coupled (e.g., through a memory bus) to the data store 642 in order to store and retrieve information desired to operate and/or confer functionality, at least in part, to the SMO component 602, the RIC 604, the RAN 606, the container component 620, the AI component 622, the processor component 640, the data store 642, and/or other component of the system 600, and/or substantially any other operational aspects of system 600.

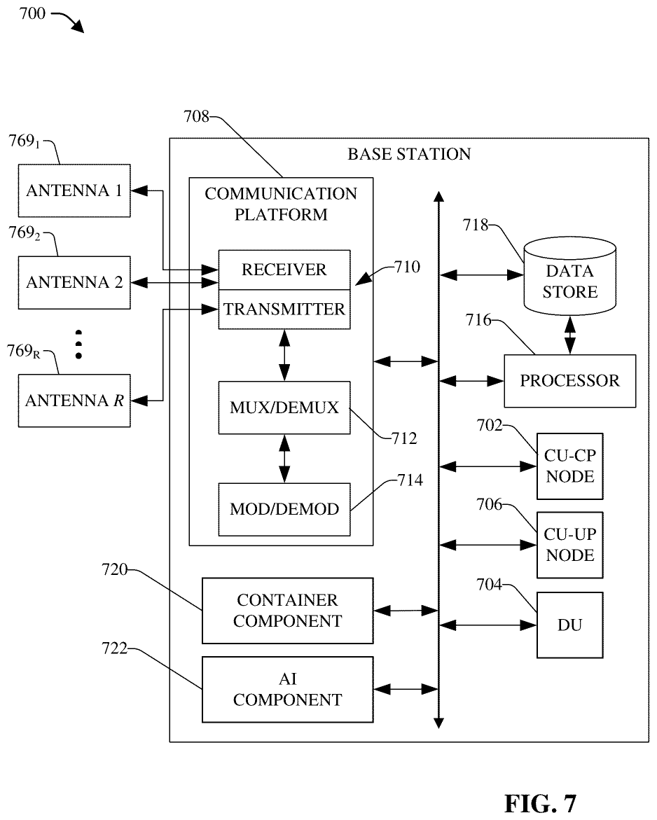

Turning to FIG. 7, FIG. 7 depicts a diagram of a non-limiting example base station 700 that can desirably facilitate (e.g., enable) connections (e.g., wireless connections) and communication of information associated with devices, in accordance with various aspects and embodiments of the disclosed subject matter. In some embodiments, the base station 700 can be a 5G or other NR base station (e.g., gNB or other NR-type or xG base station, wherein x can be a number greater than 5). In other embodiments, the base station 700 can be a 4G or LTE base station, or some other type of base station (e.g., other type of access point).

With regard to a 5G or other NR base station, the base station 700 can comprise a CU-CP node 702 (e.g., a gNB or other NR-NB CU-CP node), one or more DUs (e.g., a gNB or other NR-NB DUs), including DU 704, a desired number of CU-UP nodes (e.g., a gNB or other NR-NB CU-UP nodes), including CU-UP node 706, and/or other network equipment. The CU-CP node 702 can be associated or interfaced with the DUs (e.g., DU 704) via an interface (e.g., F1-C interface) or connection. The CU-CP node 702 can be associated or interfaced with the CU-UP nodes (e.g., CU-UP node 706) via an interface (e.g., E1 interface) or connection. The one or more CU-UP nodes (e.g., CU-UP node 706) can be associated or interfaced with the one or more DUs (e.g., DU 704) via an interface (e.g., F1-U interface) or connection.

A DU (e.g., DU 704) can provide support for lower layers of a protocol stack. For instance, a DU (e.g., DU 704) can be a logical node that can host or handle baseband (e.g., PHY) and L2 (e.g., MAC and RLC layer) functionality associated with the base station 700. A CU-UP node (e.g., CU-UP node 706) can be a logical node that can host or handle data traffic between the core network 104 (e.g., 5G or other NR or xG core network) and the DU(s) (e.g., DU 704) to which the particular CU-UP is connected. The CU-CP node 702 can be a logical node that can host or handle L3 (e.g., RRC and PDCP layer) control plane functionality associated with the base station 700.

In some embodiments, a device(s) (e.g., device(s) 112 and/or 114) can be connected to the base station 700, via the DU 704, wherein the CU-UP node 706 and the DU 704 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 700.

The base station 700 can receive and transmit signal(s) from and to wireless devices like access points (e.g., base stations, femtocells, picocells, or other type of access point), access terminals (e.g., UEs), wireless ports and routers, and the like, through a set of antennas 7691-769R. In an aspect, the antennas 7691-769R can be a part of a communication platform 708, which comprises electronic components and associated circuitry that can provide for processing and manipulation of received signal(s) and signal(s) to be transmitted. In an aspect, the communication platform 708 can include a receiver/transmitter 710 that can convert signal from analog to digital upon reception, and from digital to analog upon transmission. In addition, receiver/transmitter 710 can divide a single data stream into multiple, parallel data streams, or perform the reciprocal operation. In accordance with various embodiments, the communication platform 708 can be, can comprise, or can be associated with an RU (e.g., a gNB or other NR-NB RU node).

In an aspect, coupled to receiver/transmitter 710 can be a multiplexer/demultiplexer (mux/demux) 712 that can facilitate manipulation of signal in time and frequency space. The mux/demux 712 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 712 can scramble and spread information (e.g., codes) according to substantially any code known in the art, e.g., Hadamard-Walsh codes, Baker codes, Kasami codes, polyphase codes, and so on. A modulator/demodulator (mod/demod) 714 also can be part of the communication platform 708, and can modulate information according to multiple modulation techniques, such as frequency modulation, amplitude modulation (e.g., M-ary quadrature amplitude modulation (QAM), with M a positive integer), phase-shift keying (PSK), and the like.

The base station 700 also can comprise a processor(s) 716 that can be configured to confer and/or facilitate providing functionality, at least partially, to substantially any electronic component in or associated with the base station 700. For instance, the processor(s) 716 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 700 can include a data store 718 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices; information relating to data, files, services, applications, communication network, core network, RANs, cells, devices, users, resources, communication sessions (e.g., PDU or other communication sessions), performance indicators, containers (e.g., PDU session containers, unstructured containers, transparent containers), UE protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced container generation and communication algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 716 can employ one or more processors (e.g., one or more CPUs, accelerators, GPUs, ASICs, or other processors), microprocessors, or controllers) that can process information, and can be coupled to the data store 718 in order to store and retrieve at least some of the information (e.g., information, such as algorithms, relating to multiplexing/demultiplexing or modulation/demodulation; information relating to radio link levels; information relating to data, files, services, applications, communication network, core network, RANs, cells, devices, users, resources, communication sessions (e.g., PDU or other communication sessions), performance indicators, containers (e.g., PDU session containers, unstructured containers, transparent containers), UE protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced container generation and communication algorithms, AI algorithms, hash algorithms, data compression algorithms, data decompression algorithms, and/or other algorithm), interfaces, protocols, tools, and/or other information) desired to operate and/or confer functionality to the communication platform 708 and/or other operational components of the base station 700. The data store 718 can comprise volatile memory and/or nonvolatile memory, such as described herein.

In accordance with various embodiments, the base station 700 can comprise the container component 720 that can be associated with (e.g., communicatively connected to or part of) the CU-CP 702, DU 704, the CU-UP 706, and/or another component of or associated with the base station 700. In some embodiments, the container component 720 can be a separate component in the base station 700 (as depicted in FIG. 7), and can be associated with the DU 704 and/or one or more of the other components of the base station 700. In other embodiments, the container component 720 can be part of the DU 704. In still other embodiments, the container component 720 can be part of another component of or associated with the base station 700. The container component 720 can comprise various components and functions, and can perform various operations, such as described herein.

In accordance with various embodiments, the base station 700 can comprise the AI component 722 that can be associated with (e.g., communicatively connected to or part of) the CU-CP 702, DU 704, the CU-UP 706, and/or another component of or associated with the base station 700. In certain embodiments, the AI component 722 can be a separate component in the base station 700 (as depicted in FIG. 7), and can be associated with the DU 704 and/or one or more of the other components of the base station 700. In other embodiments, the AI component 722 can be part of the DU 704. In still other embodiments, the AI component 722 can be part of another component of or associated with the base station 700. The AI component 722 can comprise various components and functions, and can perform various operations, such as described herein.

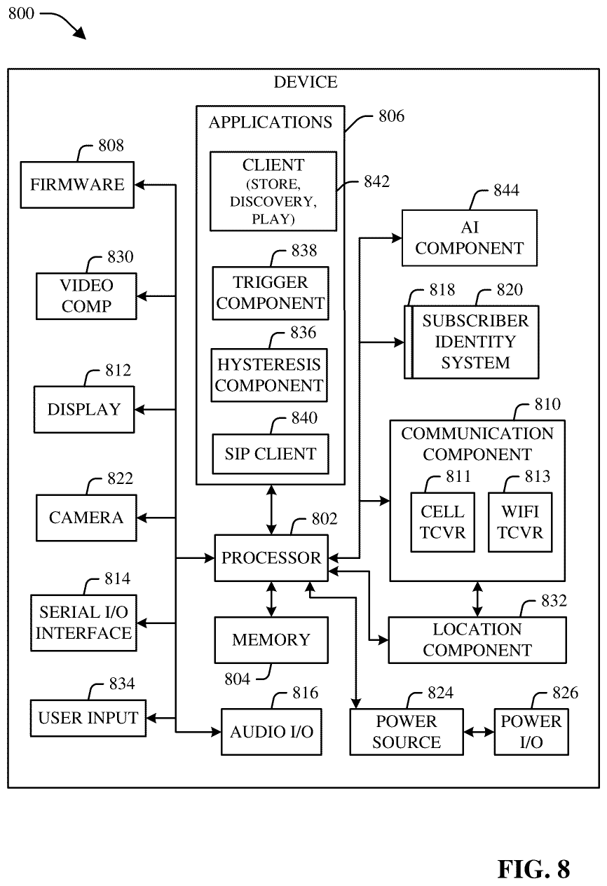

Referring to FIG. 8, FIG. 8 illustrates a diagram of a non-limiting example device 800 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 800 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 800, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 800 can include a processor(s) 802 for controlling and processing all onboard operations and functions. The processor(s) 802 can comprise one or more processors (e.g., one or more CPUs, accelerators, GPUs, ASICs, or other processors), microprocessors, or controllers) that can process information associated with the device 800. A memory 804 can interface to the processor(s) 802 for storage of data and one or more applications 806 (e.g., a video player software, user feedback component software, or other application). Other applications can include voice recognition of predetermined voice commands that facilitate initiation of the user feedback signals. Still other applications can comprise an AI application. The applications 806 can be stored in the memory 804 and/or in a firmware 808, and executed by the processor(s) 802 from either or both the memory 804 or/and the firmware 808. The firmware 808 can also store startup code for execution in initializing the device 800. A communication component 810 interfaces to the processor(s) 802 to facilitate wired/wireless communication with external systems, e.g., cellular networks, VoIP networks, and so on. Here, the communication component 810 can also include a suitable cellular transceiver 811 (e.g., a global system for mobile communication (GSM), orthogonal frequency division multiple access (OFDMA), 4G, LTE, 5G, other NR, or other type of transceiver) and/or an unlicensed transceiver 813 (e.g., Wi-Fi, WiMax) for corresponding signal communications. The device 800 can be a device such as a cellular telephone, a PDA with mobile communications capabilities, and messaging-centric devices. The communication component 810 also facilitates communications reception from terrestrial radio networks (e.g., broadcast), digital satellite radio networks, and Internet-based radio services networks.

The device 800 includes a display 812 for displaying text, images, video, telephony functions (e.g., a Caller ID function), setup functions, and for user input. For example, the display 812 can also be referred to as a “screen” that can accommodate the presentation of multimedia content (e.g., music metadata, messages, wallpaper, graphics, etc.). The display 812 can also display videos and can facilitate the generation, editing and sharing of video quotes. A serial I/O interface 814 is provided in communication with the processor(s) 802 to facilitate wired and/or wireless serial communications (e.g., USB, and/or IEEE 1394) through a hardwire connection, and other serial input devices (e.g., a keyboard, keypad, and mouse). This supports updating and troubleshooting the device 800, for example. Audio capabilities are provided with an audio I/O component 816, which can include a speaker for the output of audio signals related to, for example, indication that the user pressed the proper key or key combination to initiate the user feedback signal. The audio I/O component 816 also facilitates the input of audio signals through a microphone to record data and/or telephony voice data, and for inputting voice signals for telephone conversations.

The device 800 can include a slot interface 818 for accommodating a SIC (Subscriber Identity Component) in the form factor of a card Subscriber Identity Module (SIM) or universal SIM 820, and interfacing the SIM card 820 with the processor(s) 802. However, it is to be appreciated that the SIM card 820 can be manufactured into the device 800, and updated by downloading data and software.

The device 800 can process IP data traffic through the communication component 810 to accommodate IP traffic from an IP network such as, for example, the Internet, a corporate intranet, a home network, a person area network, etc., through an ISP or broadband cable provider. Thus, VoIP traffic can be utilized by the device 800 and IP-based multimedia content can be received in either an encoded or a decoded format.

A video processing component 822 (e.g., a camera) can be provided for decoding encoded multimedia content. The video processing component 822 can aid in facilitating the generation, editing, and sharing of video quotes. The device 800 also includes a power source 824 in the form of batteries and/or an AC power subsystem, which power source 824 can interface to an external power system or charging equipment (not shown) by a power I/O component 826.

The device 800 can also include a video component 830 for processing video content received and, for recording and transmitting video content. For example, the video component 830 can facilitate the generation, editing and sharing of video quotes. A location tracking component 832 facilitates geographically locating the device 800. As described hereinabove, this can occur when the user initiates the feedback signal automatically or manually. A user input component 834 facilitates the user initiating the quality feedback signal. The user input component 834 can also facilitate the generation, editing and sharing of video quotes. The user input component 834 can include such conventional input device technologies such as a keypad, keyboard, mouse, stylus pen, and/or touch screen, for example.

Referring again to the applications 806, a hysteresis component 836 facilitates the analysis and processing of hysteresis data, which is utilized to determine when to associate with the access point. A software trigger component 838 can be provided that facilitates triggering of the hysteresis component 836 when the Wi-Fi transceiver 813 detects the beacon of the access point. A SIP client 840 enables the device 800 to support SIP protocols and register the subscriber with the SIP registrar server. The applications 806 can also include a client 842 that provides at least the capability of discovery, play and store of multimedia content, for example, music.

The device 800, as indicated above related to the communication component 810, includes an indoor network radio transceiver 813 (e.g., Wi-Fi transceiver). This function supports the indoor radio link, such as IEEE 802.11, for the dual-mode GSM device (e.g., device 800). The device 800 can accommodate at least satellite radio services through a device (e.g., handset device) that can combine wireless voice and digital radio chipsets into a single device (e.g., single handheld device).

In some embodiments, the device 800 can comprise the AI component 844 that can perform AI and/or ML functions and operations, and can generate, train, and/or update one or more AI models (e.g., AI models, ML models, neural network models, and/or other models, which can be local AI models of the device 800), such as described herein. The AI component 844 and/or the one or more AI-based models can generate AI-related data that can be communicated to the core network (e.g., to the AF or AI component of or associated with the core network), and/or can receive AI-related data from the core network (e.g., AI-related data from the AI component or global AI model of the core network to facilitate updating a local AI model(s) of the device 800), such as described herein.

It is to be appreciated and understood that one or more components (e.g., the devices, configuration manager component, base station, core network, or other component) of the systems (e.g., system 100, system 200, system 600, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

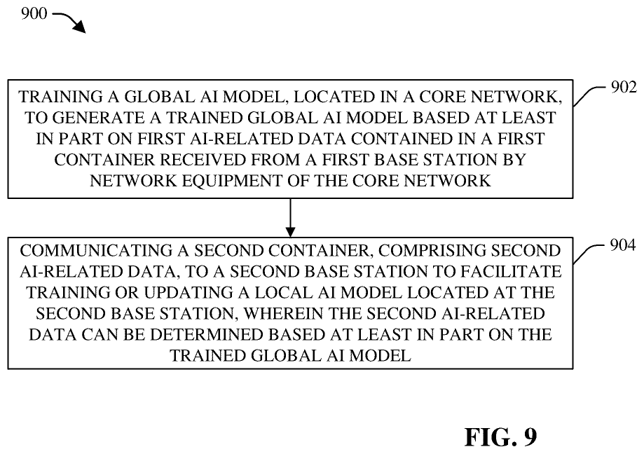

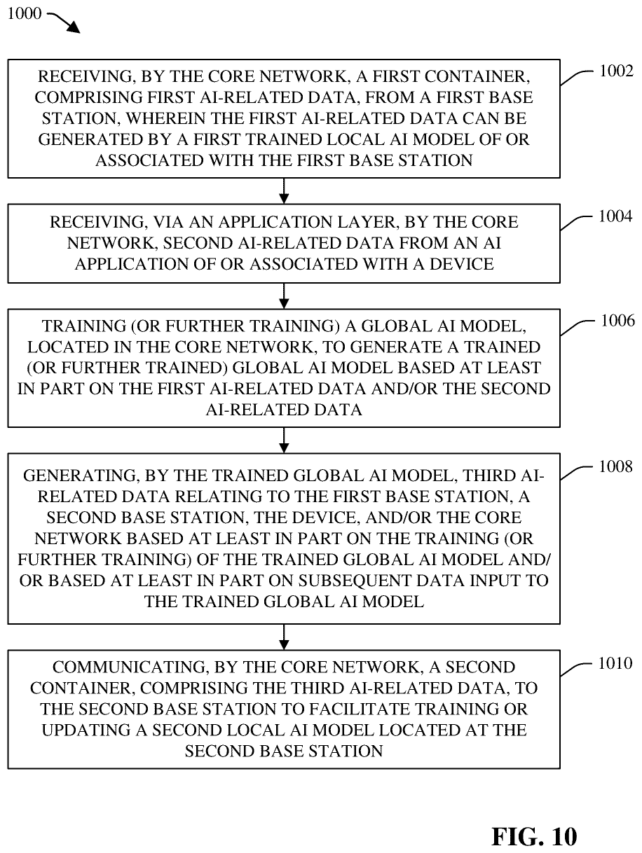

In view of the example systems and/or devices described herein, example methods that can be implemented in accordance with the disclosed subject matter can be further appreciated with reference to flowcharts in FIGS. 9-10. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 9 illustrates a flow chart of an example method 900 that can desirably (e.g., automatically, dynamically, suitably, reliably, efficiently, enhancedly, and/or optimally) manage distributed and federated learning to train a global AI model associated with the core network based on first AI-related data received from a first base station and communicate second AI-related data generated by the global AI model to a second base station to train a local AI model associated with the second base station, in accordance with various aspects and embodiments of the disclosed subject matter. The method 900 can be employed by, for example, a system comprising the AF, application server, UPF, AI component, and container manager component that can comprise or be associated with the processor component, the data store, and/or other components.

At 902, a global AI model, located in a core network, can be trained to generate a trained global AI model based at least in part on first AI-related data contained in a first container received from a first base station by network equipment of the core network. The UPF of the core network can receive the first container, comprising the first AI-related data (e.g., unstructured first AI-related PDUs), from the first base station (e.g., via the N3 interface). The AF or application server of or associated with the core network can comprise or be associated with the AI component that can comprise the trainer component, such as described herein. The UPF can communicate the first AI-related data to the AF or associated application server. In some embodiments, the AF or application server also can receive (e.g., via the UPF or application layer) other AI-related data from one or more other base stations (e.g., via one or more other containers, comprising other unstructured AI-related data) of the RAN(s), one or more devices (e.g., via one or more respective AI/ML applications), and/or one or more other data sources (e.g., one or more data source devices) associated with the core network.

The trainer component can input the first AI-related data (e.g., AI data, ML data, AI-related training data, or other AI-related data) and/or the other AI-related data into the global AI model (e.g., an untrained or trained global AI model). The global AI model can be an AI, ML, neural network, or other AI-based model. The global AI model can analyze (e.g., can perform an AI-based analysis on) the first AI-related data and/or the other AI-related data. Based at least in part on the results of such analysis of the first AI-related data and/or the other AI-related data, the global AI model can be trained or further trained (e.g., updated or refined) to make (e.g., render or output) predictions, inferences, probabilities, determinations, or decisions, and/or provide other output data relating to operations of the core network, the RAN(s), and/or devices. For instance, the trained global AI model can receive subsequent data (e.g., data relating to the RAN(s), the devices, the core network), and can analyze such subsequent data. Based at least in part on the results of analyzing (e.g., performing an AI-based analysis on) such subsequent data, and the training of the trained global AI model, the global AI model can (e.g., render or output) predictions, inferences, probabilities, determinations, or decisions, and/or provide other output data relating to operations of the core network, the RAN(s) (e.g., the base stations of the RAN(s)), and/or devices, such as described herein.

At 904, a second container, comprising second AI-related data, can be communicated to a second base station to facilitate training or updating a local AI model located at the second base station, wherein the second AI-related data can be determined based on the trained global AI model. The trained global AI model can generate the second AI-related data based at least in part on data (e.g., the subsequent data) input to and analyzed by the trained global AI model. In some embodiments, the second AI-related data can relate to operations of the second base station. The AF or application server, and/or the UPF, of the core network can communicate (e.g., via the N3 interface) the second container, comprising the second AI-related data (e.g., second unstructured AI-related PDUs), to the second base station (e.g., of the RAN or another RAN) to facilitate such training or updating of the local AI model located at the second base station, such as described herein. The second base station can employ an associated AI component (e.g., the AI component of the RAN that comprises the second base station) that can input the second AI-related data into the local AI model of the second base station to train or update (e.g., refine or further train) the local AI model to facilitate enhancing operations of the local AI model and the second base station.

FIG. 10 depicts a flow chart of an example method 1000 that can desirably (e.g., automatically, dynamically, suitably, reliably, efficiently, enhancedly, and/or optimally) manage distributed and federated learning to train (e.g., iteratively train) a global AI model associated with the core network based on first AI-related data received from a first base station and second AI-related data received from a device, and communicate third AI-related data generated by the global AI model to a second base station to train (e.g., iteratively train) a local AI model associated with the second base station, in accordance with various aspects and embodiments of the disclosed subject matter. The method 1000 can be employed by, for example, a system comprising the AF, application server, UPF, AI component, and container manager component that can comprise or be associated with the processor component, the data store, and/or other components.

At 1002, a first container, comprising first AI-related data, can be received by the core network from a first base station, wherein the first AI-related data can be generated by a first trained local AI model of or associated with the first base station. The UPF of the core network can receive the first container, comprising the first AI-related data (e.g., first unstructured or transparent AI-related data), from the first base station. The first AI-related data can relate to operations of the first base station and/or devices associated with the first base station. The UPF can forward (e.g., send or communicate) the first AI-related data to the AF or application server.

At 1004, second AI-related data can be received, via an application layer, by the core network from an AI application of or associated with a device. In some embodiments, the AF or application server of the core network can receive, via the application layer (e.g., via an application layer data exchange), the second AI-related data, from the AI application of or associated with the device. In certain embodiments, a trained local AI model of or associated with the device can generate the second AI-related data based at least in part on the results of analyzing device-related information associated with the device and/or one or more base stations that are or were associated with the device.

At 1006, a global AI model, located in the core network, can be trained to generate a trained (or further trained) global AI model based at least in part on the first AI-related data and/or the second AI-related data. The AF or application server of or associated with the core network can comprise or be associated with the AI component that can comprise the trainer component, such as described herein. In some embodiments, in addition to receiving the first AI-related data and the second AI-related data, the AF or application server also can receive (e.g., via the UPF or application layer) other AI-related data from one or more other base stations (e.g., via one or more other containers, comprising other unstructured or transparent AI-related data) of the RAN(s), one or more other devices (e.g., via one or more other AI/ML applications), and/or one or more other data sources (e.g., one or more data source devices) associated with the core network.

The trainer component can input the first AI-related data (e.g., AI data, ML data, AI-related training data, or other AI-related data), the second AI-related data, and/or the other AI-related data into the global AI model (e.g., the untrained or trained global AI model). The global AI model can be an AI, ML, neural network, or other AI-based model. The global AI model can analyze (e.g., can perform an AI-based analysis on) the first AI-related data, the second AI-related data, and/or the other AI-related data. Based at least in part on the results of such analysis, the global AI model can be trained or further trained (e.g., updated or refined) to make (e.g., render or output) predictions, inferences, probabilities, determinations, or decisions, and/or provide other output data relating to operations of the core network, the RAN(s), and/or devices. For instance, the trained global AI mode can generate (e.g., render or output) predictions, inferences, probabilities, determinations, decisions, and/or other output data relating to operations of the core network, the RAN(s) (e.g., the base stations of the RAN(s)), and/or devices, such as described herein.

At 1008, the trained global AI model can generate third AI-related data relating to the first base station, a second base station, the device, and/or the core network based at least in part on the training (or further training) of the trained global AI model and/or based at least in part on subsequent data input to the trained global AI model. For example, the trained global AI model can generate the third AI-related data based at least in part on the training (or further training) of the trained global AI model; and/or the trained global AI model can receive subsequent data (e.g., AI-related data or other data relating to the RAN(s), the devices, the core network), and can analyze such subsequent data, and based at least in part on the results of analyzing (e.g., performing an AI-based analysis on) such subsequent data, and the training (or further training) of the trained global AI model, the trained global AI model can determine and generate the third AI-related data.

At 1010, the core network can communicate a second container, comprising the third AI-related data, to the second base station to facilitate training or updating a second local AI model located at the second base station. The AF or associated application server can generate a second container, comprising the third AI-related data (e.g., third unstructured or transparent AI-related data). The AF or application server can communicate the second container, comprising the third AI-related data, to the UPF. The UPF can communicate the second container, comprising the third AI-related data, to the second base station (e.g., via the N3 interface) to facilitate training or updating the second local AI model based at least in part on the third AI-related data. The second base station can employ the trained and/or updated second local AI model to generate (e.g., render or output) predictions, inferences, probabilities, determinations, or decisions, and/or other output data relating to operations of one or more devices associated with the second base station and/or operations of the second base station (e.g., based at least in part on input data input to and analyzed by the second trained local AI model), such as described herein.

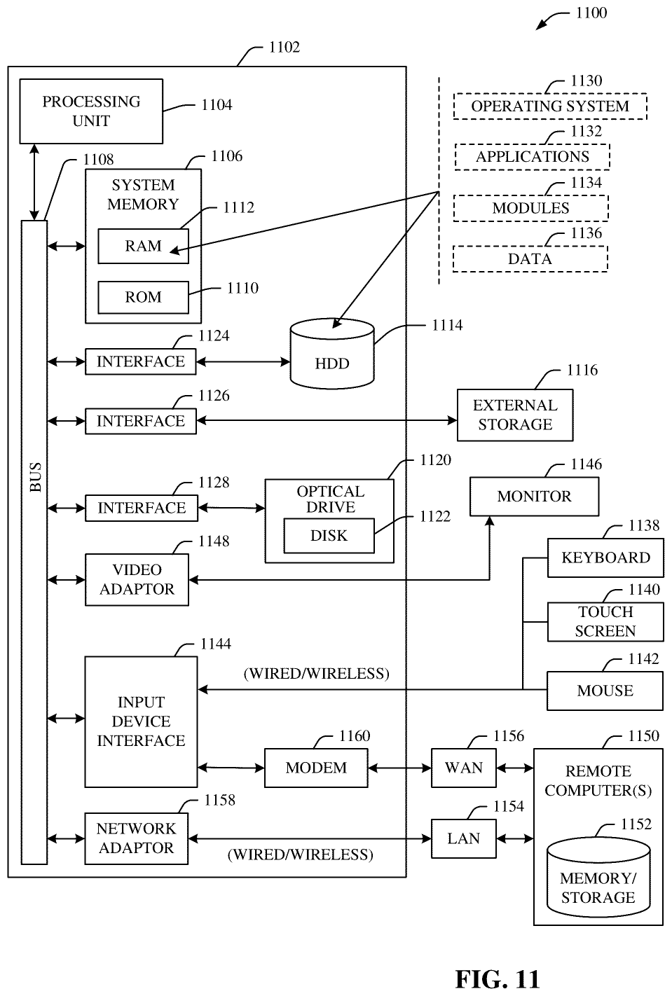

In order to provide additional context for various embodiments described herein, FIG. 11 and the following discussion are intended to provide a brief, general description of a suitable computing environment 1100 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 also can be configured for external use in a suitable chassis (not shown).

Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156, e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, UPF, AF, application server, communication manager component, container manager component, container component, AI component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
training, by a system comprising at least one processor, a global artificial intelligence model located in a core network to generate a trained global artificial intelligence model based on first artificial intelligence-related data contained in a first container received from a first base station by network equipment of the core network; and
communicating, by the system, a second container, comprising second artificial intelligence-related data, to a second base station to facilitate training or updating a local artificial intelligence model located at the second base station, wherein the second artificial intelligence-related data is determined based on the trained global artificial intelligence model.

2. The method of claim 1, wherein the first container or the second container is an unstructured container or a transparent container.

3. The method of claim 2, wherein the first container is the unstructured container or the transparent container, and wherein the method further comprises:
receiving, by a user plane function of the core network of the system, the first container, comprising the first artificial intelligence-related data, from the first base station,
wherein one of:
a general-packet-radio-service tunneling protocol-user plane extension header associated with the unstructured container is encoded, wherein the first artificial intelligence-related data is unstructured data, or
a protocol data unit type relating to uplink transparent data is encoded with regard to the transparent container, wherein the first artificial intelligence-related data is the uplink transparent data.

4. The method of claim 2, wherein the first container is the unstructured container or the transparent container, and wherein the method further comprises:
encoding, by the system, a general-packet-radio-service tunneling protocol-user plane extension header associated with the unstructured container, wherein the second artificial intelligence-related data is unstructured data; or
encoding, by the system, a protocol data unit type relating to downlink transparent data with regard to the transparent container, wherein the second artificial intelligence-related data is the downlink transparent data.

5. The method of claim 4, wherein the communicating comprises communicating, using a user plane function of the core network, the unstructured container or the transparent container, comprising the second artificial intelligence-related data, to the second base station.

6. The method of claim 1, wherein the trained global artificial intelligence model comprises a trained global machine learning model or a trained global neural network model,
wherein the local artificial intelligence model is trained, based on the second artificial intelligence-related data, to generate a trained local artificial intelligence model, and
wherein trained local artificial intelligence model comprises a trained local machine learning model or a trained local neural network model.

7. The method of claim 1, wherein the first artificial intelligence-related data comprises first artificial intelligence model data, first machine learning model data, or first neural network model data, and
wherein the second artificial intelligence-related data comprises second artificial intelligence model data, second machine learning model data, or second neural network model data.

8. The method of claim 1, further comprising:
receiving, by the system via an application layer, third artificial intelligence-related data from an artificial intelligence application associated with a device, wherein the training of the global artificial intelligence model comprises training the global artificial intelligence model, based on the first artificial intelligence-related data and the third artificial intelligence-related data, to generate the trained global artificial intelligence model.

9. The method of claim 1, wherein the local artificial intelligence model is a second local artificial intelligence model, and wherein the method further comprises:
receiving, by the network equipment of the core network of the system, a third container, comprising third artificial intelligence-related data, from the second base station;
updating, by the system, the trained global artificial intelligence model, based on the third artificial intelligence-related data, to generate an updated trained global artificial intelligence model;
determining, by the updated trained global artificial intelligence model of the system, fourth artificial intelligence-related data based on input data that is input to the updated trained global artificial intelligence model; and
communicating, by the system, a fourth container, comprising the fourth artificial intelligence-related data, to a first base station to facilitate training or updating a first local artificial intelligence model, located at the first base station, based on the fourth artificial intelligence-related data.

10. The method of claim 1, wherein the local artificial intelligence model is trained or updated, based on the second artificial intelligence-related data, to generate a trained or updated local artificial intelligence model, wherein the trained or updated local artificial intelligence model determines or infers an action to be performed based on input data input to the trained or updated local artificial intelligence model, and wherein the action relates to the second base station or a device associated with the second base station.

11. The method of claim 1, wherein the local artificial intelligence model is a second local artificial intelligence model located at the second base station, and wherein the method further comprises:
receiving, by the network equipment of the core network of the system, a third container, comprising third artificial intelligence-related data, from the second base station; and
communicating, by the system, a fourth container, comprising the third artificial intelligence-related data, to the first base station to facilitate training or updating a first local artificial intelligence model, located at the first base station, based on the fourth artificial intelligence-related data.

12. The method of claim 1, wherein a third container, comprising third artificial intelligence-related data, is communicated between the first base station and the second base station via an interface between the first base station and the second base station.

13. A system, comprising:
at least one memory that stores computer executable components; and
at least one processor that executes computer executable components stored in the at least one memory, wherein the computer executable components comprise:
a model trainer that trains a first artificial intelligence model located in a core network, based on first artificial intelligence-related information, to generate a trained first artificial intelligence model, wherein a first container, comprising the first artificial intelligence-related information, is received from a first base station by network equipment of the core network; and
an application function that transmits a second container, comprising second artificial intelligence-related information, to a second base station to facilitate training a second artificial intelligence model located at the second base station, wherein the second artificial intelligence-related information is determined based on the trained first artificial intelligence model.

14. The system of claim 13, wherein the first container or the second container is an unstructured container or a transparent container,
wherein the first artificial intelligence-related information comprises unstructured or transparent first artificial intelligence-related information, and
wherein the second artificial intelligence-related information comprises unstructured or transparent second artificial intelligence-related information.

15. The system of claim 13, wherein the trained first artificial intelligence model comprises a trained first machine learning model or a trained first neural network model, or
wherein the second artificial intelligence model is trained, based on the second artificial intelligence-related information, to generate a trained second artificial intelligence model, and wherein the trained second artificial intelligence model comprises a trained second machine learning model or a trained second neural network model.

16. The system of claim 13, wherein the first artificial intelligence-related information comprises first artificial intelligence model information, first machine learning model information, or first neural network model information, and
wherein the second artificial intelligence-related information comprises second artificial intelligence model information, second machine learning model information, or second neural network model information.

17. The system of claim 13, wherein the application function receives, via an application layer, third artificial intelligence-related information from an artificial intelligence application of a user equipment, and
wherein the model trainer trains the first artificial intelligence model, based on the first artificial intelligence-related information and the third artificial intelligence-related information, to generate the trained first artificial intelligence model.

18. The system of claim 13, wherein the first container is an unstructured container or a transparent container, and wherein the computer executable components further comprise:
a user plane function that encodes a general-packet-radio-service tunneling protocol-user plane extension header associated with the unstructured container, or encodes a protocol data unit type relating to downlink transparent information with regard to the transparent container, wherein the second artificial intelligence-related information is downlink unstructured information or the downlink transparent information.

19. A non-transitory machine-readable medium, comprising executable instructions that, when executed by at least one processor, facilitate performance of operations, comprising:
receiving, by network equipment of a core network, a first container, comprising first artificial intelligence-related data, from a first base station, wherein a first artificial intelligence model located in the core network is trained, based on the first artificial intelligence-related data, to generate a trained global artificial intelligence model; and
communicating a second container, comprising second artificial intelligence-related data, to a second base station to facilitate training or updating a second artificial intelligence model located at the second base station, wherein the second artificial intelligence-related data is determined based on the trained first artificial intelligence model.

20. The non-transitory machine-readable medium of claim 19, wherein the first container or the second container is an unstructured container or a transparent container,
wherein the first artificial intelligence-related data comprises first unstructured or transparent data that comprises first artificial intelligence model data, first machine learning model data, or first neural network model data, and
wherein the second artificial intelligence-related data comprises second unstructured or transparent data that comprises second artificial intelligence model data, second machine learning model data, or second neural network model data.
